(19) United States
(12) Patent Application Publication
(10) Pub. No.: US 2020/0210818 A1
(43) Pub. Date: Jul. 2, 2020

(54) ARRAY DEVICE INCLUDING NEUROMORPHIC ELEMENT AND NEURAL NETWORK SYSTEM

(71) Applicant: TDK CORPORATION, Tokyo (JP)

(72) Inventor: Yukio TERASAKI, Tokyo (JP)

(73) Assignee: TDK CORPORATION, Tokyo (JP)

(21) Appl. No.: 16/325,259

(22) PCT Filed: Aug. 3, 2018
(86) PCT No.: PCT/JP2018/029208

§ 371 Date: Feb. 13, 2019

(30) Foreign Application Priority Data
Nov. 2, 2017 (JP) 2017-213195

(51) Int. Cl. G06N 3/063; G06N 3/08; G06N 3/04

(52) U.S. Cl. CPC G06N 3/063; G06N 3/04; G06N 3/08

(57) ABSTRACT

An array device includes: a first array area that includes a neuromorphic element which is configured to multiply a signal by a weight corresponding to a variable characteristic value and outputs a first signal which is a result of processing an input signal using the neuromorphic element; and a retention unit that is able to retain the first signal output from the first array area or a second signal which is output when the first signal is input to a predetermined computing unit and is configured to input the retained first signal or the retained second signal to the first array area.

### TECHNICAL FIELD

The invention relates to an array device including a neuromorphic element and a neural network system.

Priority is claimed on Japanese Patent Application No. 2017-213195, filed Nov. 2, 2017, the content of which is incorporated herein by reference.

### BACKGROUND ART

Conventionally, neural network technology has been studied (for example, see Patent Documents 1 to 3).

Identification or classification of advanced information can be carried out using neural network technology. Such technology of a neural network is put into practice in a wide range of fields such as deep learning, medical care, health care, finance, marketing, authentication, and security.

The technology of a recurrent neural network has also been studied.

In a recurrent neural network, a hidden layer of a neural network such as a multilayer perceptron is coupled to a subsequent-stage layer (for example, an output layer) and a layer (a recurrent layer) which is recurrently coupled to an input of the hidden layer is also provided. A weight of the recurrent layer is a combination of all units of the hidden layer in a round-robin manner.

A learning algorithm for the weight of a recurrent layer has been widely studied and, for example, back propagation through time (BPTT) is known.

Here, a recurrent layer handles a component of a temporal (or spatial) delay and can be understood to implement the same function as a memory.

With a configuration including a memory gate mechanism in addition to the above-mentioned simple recurrent layer, a long short-term memory (LSTM) having a long short-term plastic memory function is implemented. That is, a learning function in which information at a current time t and information at a previous time (for example, time (t-1), time (t-2), . . . ) which is longer than the current time are connected can be implemented with a recurrent layer.

Here, a wide range of technology having various recurrent configurations may be included regarding a recurrent neural network.

For example, a reservoir and an Elman net in addition to an LSTM have been proposed as a technique for realizing a recurrent neural network.

In a recurrent neural network, since recurrent elements are provided, identification information can be acquired using a temporal (or spatial) context. Accordingly, a recurrent neural network can be effectively used to extract advanced information from continuous signals.

A recurrent neural network is suitable, for example, for identification, prediction, abnormality detection, and other analysis of time-series signals and is expected to be able to be applied to various fields of a nonlinear filter for time-series signals of a sensor the like, technology for understanding or determining a word from the context thereof, technology for extracting information from noise, technology for natural language processing in a translator or the like, and technology of artificial intelligence (AI) as specific examples.

Recently, a new computing mechanism that can perform a product-sum operation with low power at a high speed using a neuromorphic element in which conductance (a reciprocal of resistance) varies in an analog manner has been researched. This computing mechanism can be applied to a neural network.

However, when a recurrent neural network is configured using neuromorphic elements, it is necessary to connect the neuromorphic elements in an array form and to introduce a recurrent mechanism. In order to improve an identification speed in a recurrent neural network, it is necessary to appropriately design a configuration of a physical array suitable for processing on a time axis and mapping on the physical array.

A recurrent neural network itself is a structure which has been proposed in the past, but had not progressed beyond the area of academic research until several years ago, since a recurrent neural network consumes a large amount of computing resources similarly to other neural networks. However, scaling of complementary metal oxide semiconductor (CMOS) and the hardware performance of a graphics processing unit (GPU) or the like have significantly improved, and practical application using general-purpose computing on graphics processing units (GPGPU) or a central processing unit (CPU) has progressed mainly to the fields of a convolutional neural network (CNN), deep neural network (DNN), and the like.

For example, Patent Document 1 discloses a technique of optimally mapping resources required for implementing a recurrent neural network system on a GPGPU or the like.

In “SYSTEM AND METHOD FOR MULTICORE-OPTIMIZED RECURRENT NEURAL NETWORK” described in Patent Document 1, a technique of mapping resources required for implementing a recurrent neural network on modern processor resources is disclosed. Specifically, a load balancing effect is achieved by configuring a recurrent neural network using a multi-bulk synchronization parallel (MBSP) model which is a multi-parallel model of microprocessors including an arithmetic and logic unit (ALU) and a memory and efficiently mapping signals of temporal recurrence with hardware modules having different coupling densities or bands.

### CITATION LIST

### Patent Literature

### [Patent Document 1]

Japanese Unexamined Patent Application, First Publication No. 2017-107568

### [Patent Document 2]

Published Japanese Translation No. 2017-516192 of the PCT International Publication

### [Patent Document 3]

Japanese Unexamined Patent Application, First Publication No. H7-84974

### SUMMARY OF INVENTION

### Technical Problem

As described above, researches and applications of computing optimization of a recurrent neural network, load balancing, and the like have conventionally progressed using a computer. However, since enormous product-sum computing mechanisms are necessary, devices such as large-scale processors or a GPGPU have been required. A GPGPU, the processors, or the like have a fixed hardware structure, and thus it is difficult to use them for optimization such as implementation with a changed structure of a neural network.

In addition, although there is a likelihood that recurrent computing will be used, for example, in fields other than the neural network, in this case, improvement thereof is expected.

This invention has been realized in consideration of the above-mentioned circumstances and an objective thereof is to provide an array device and a neural network system including a neuromorphic element that can perform a recurrent computing operation using a neuromorphic element.

### Solution to Problem

According to an aspect of the invention, there is provided an array device including: a first array area that includes a neuromorphic element which is configured to multiply a signal by a weight corresponding to a variable characteristic value and that is configured to output a first signal which is a result of processing an input signal using the neuromorphic element; and a retention unit that is able to retain the first signal output from the first array area or a second signal which is output when the first signal is input to a predetermined computing unit and is configured to input the retained first signal or the retained second signal to the first array area.

According to an aspect of the invention, in the array device, the retention unit includes a capacitive element that is configured to store a current corresponding to the first signal or the second signal and a switching circuit that is configured to perform charging/discharging switching of the capacitive element.

According to an aspect of the invention, in the array device, the retention unit may retain data after the current corresponding to the first signal or the second signal has been converted into a digital value.

According to an aspect of the invention, in the array device, the first signal or the second signal which is input from the retention unit to the first array area may be synchronized with another signal which is input to the first array area.

According to an aspect of the invention, in the array device, the first signal or the second signal which is input from the retention unit to the first array area and the other signal which is input to the first array area may both be data in discrete unit times, and the other signal is a signal which is temporally subsequent to the first signal or the second signal which is input from the retention unit to the first array area.

According to an aspect of the invention, in the array device, the first signal or the second signal which is input from the retention unit to the first array area and the other signal which is input to the first array area may be output via the same line.

According to an aspect of the invention, in the array device, the first array area may include a plurality of different areas including a common line and output signals from the plurality of areas as the first signal, and the retention unit may be able to retain the second signal which is output when the signals output from the plurality of areas of the first array area are input to the computing unit and input the retained second signal to one or more of the plurality of areas of the first array area.

According to an aspect of the invention, there is provided a neural network system including the above-mentioned array device and performing processing of a neural network.

### Advantageous Effects of Invention

According to an aspect of the invention, it is possible to perform a recurrent computing operation using neuromorphic elements.

### BRIEF DESCRIPTION OF DRAWINGS

FIG. 1 is a diagram schematically showing a configuration of an array device according to an embodiment (a first embodiment) of the invention.

FIG. 2 is a diagram schematically showing processes in the array device according to the embodiment (the first embodiment) of the invention.

FIG. 3 is a diagram schematically showing a configuration of an array device according to an embodiment (a second embodiment) of the invention.

FIG. 4 is a diagram schematically showing a configuration of a neural network system according to an embodiment (a third embodiment) of the invention.

FIG. 5 is a diagram schematically showing a configuration of an array device according to an embodiment (a fourth embodiment) of the invention.

FIG. 6 is a diagram schematically showing a configuration of a neuromorphic element according to an embodiment (a fifth embodiment) of the invention.

FIG. 7 is a diagram schematically showing a configuration of a retention mechanism according to an embodiment (a sixth embodiment) of the invention.

FIG. 8 is a diagram schematically showing a configuration of a line common to a plurality of arrays according to an embodiment (a seventh embodiment) of the invention.

FIG. 9 is a block diagram showing a conceptual configuration of an array unit in a recurrent neural network system.

FIG. 10 is a block diagram schematically showing a flow of signals in an array unit in a recurrent neural network system.

### DESCRIPTION OF EMBODIMENTS

Hereinafter, embodiments of the invention will be described with reference to the accompanying drawings.

### Definition of Terms in Embodiments

In the following description, for the purpose of convenience of description, terms including “array,” “array area,” “array unit,” and “array system” are used.

In the embodiments, an “array” refers to an individual integrated element group which is physically independent, that is, refers to a single integrated element group.

In the embodiments, an “array area” refers to an area of an array and may be, for example, the whole area of an array or a part of the area of an array. For example, the area of an array may be divided into a plurality of sub-areas and the array may be used in a division manner using the sub-areas (the separate areas). When there are two or more array areas, for example, the two or more array areas may be sub-areas of the same array or the two or more array areas may be areas of two or more different arrays.

In the embodiments, an “array unit” refers to a part (a basic functional unit) including an array for implementing one layer of a neural network and other circuits. The other circuits may include, for example, one or more of a circuit for input, a circuit for output, a circuit of a clock, and an activation function circuit.

In the embodiments, an “array system” refers to a system including a plurality of array units and refers to, for example, the whole system capable of implementing a discerner of a neural network or the like.

In the embodiments, an “array device” refers to an arbitrary device including an array and may be, for example, an array, an array unit, or an array system.

In the embodiments, when a signal is not explicitly mentioned as being an analog signal or a digital signal, an analog signal may be used or a digital signal (a digital value) may be used.

[Outline of Recurrent Neural Network System]

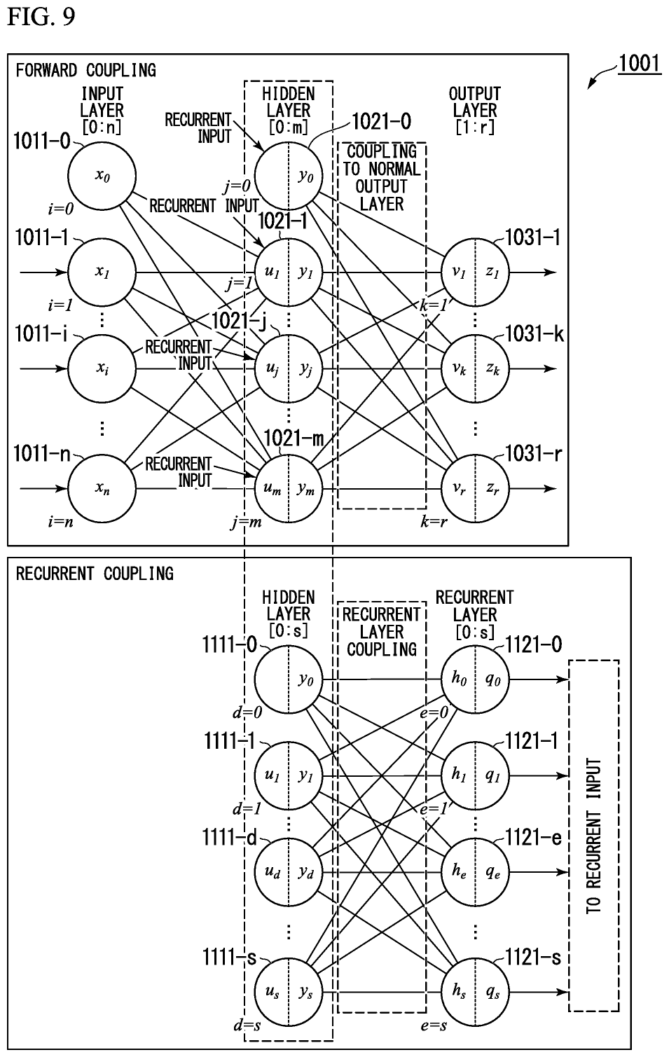

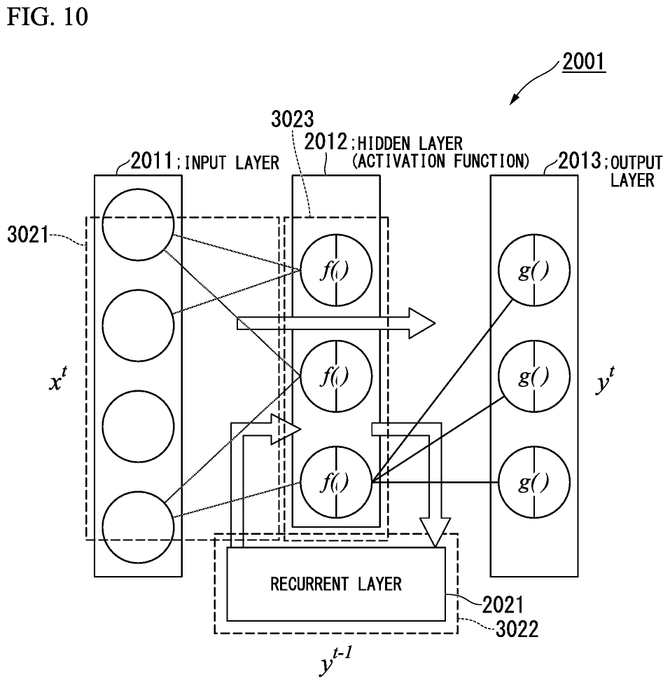

First, a recurrent neural network system will be described with reference to FIGS. 9 and 10.

FIG. 9 is a block diagram showing a conceptual configuration of an array unit 1001 in a recurrent neural network system.

In the example shown in FIG. 9, three layers of perceptrons are used.

The array unit 1001 receives inputs of n (where n is an integer equal to or greater than 1) signals and outputs r (where r is an integer equal to or greater than 1) signals.

The array unit 1001 includes n units 1011-1 to 1011-n and one unit 1011-0 of a bias term outputting a predetermined value in an input layer.

Regarding forward coupling, the array unit 1001 includes m (where m is an integer equal to or greater than 1) units 1021-1 to 1021-m and one unit of a bias term 1021-0 outputting a predetermined value in a hidden layer.

The array unit 1001 includes r (where r is an integer equal to or greater than 1) units 1031-1 to 1031-r in an output layer.

Regarding recurrent coupling, the array unit 1001 includes s (where s is an integer equal to or greater than 1) units 1111-1 to 1111-s and one unit 1111-0 of a bias term outputting a predetermined value in a hidden layer.

Regarding recurrent coupling, the array unit 1001 includes (s+1) units 1121-0 to 1121-s in a recurrent layer (a memory layer).

In the example shown in FIG. 9, an input signal (an input value) xᵢ in the input layer in the forward coupling is expressed by i=1 to n. When i=0 is set, the value xᵢ is a predetermined value.

In the example shown in FIG. 9, a signal (a value which is substituted into an activation function) uⱼ in the hidden layer in the forward coupling is expressed by j=1 to m and a value yⱼ which is a result of substitution of the signal into an activation function is expressed by j=1 to m. The activation function need not necessarily be used. When j=0 is set, the value yᵢ is a predetermined value.

In the example shown in FIG. 9, a signal (a value which is substituted into an activation function) vₖ in the output layer in the forward coupling is expressed by k=1 to r and a value zₖ which is a result of substitution of the signal into an activation function is expressed by k=1 to r. The activation function need not necessarily be used.

In the example shown in FIG. 9, a signal (a value which is substituted into an activation function) u_{d} in the hidden layer in the recurrent coupling is expressed by d=1 to s and a value y_{d} which is a result of substitution of the signal into an activation function is expressed by d=1 to s. The activation function need not necessarily be used. When d=0 is set, the value y_{d} is a predetermined value.

In the example shown in FIG. 9, a signal (a value which is substituted into an activation function) hₑ in the recurrent layer in the recurrent coupling is expressed by e=0 to s and a value qₑ which is a result of substitution of the signal into an activation function is expressed by e=0 to s. The activation function need not necessarily be used.

Here, in the embodiments, it is assumed that (m+1) which is the number of units in the hidden layer in the forward coupling and (s+1) which is the number of units in the hidden layer in the recurrent coupling are the same, that is, s=m is assumed. For example, a configuration in which s and m are not the same may be used and, for example, a configuration in which s is smaller than m may be used.

The units 1011-1 to 1011-n in the input layer receive and output n input signals (input values).

The unit 1011-0 in the input layer outputs a predetermined signal (value).

The units 1021-1 to 1021-m in the hidden layer add signals (values) which are results of a product-sum operation which is performed on output signals (output values) from the (n+1) units 1011-0 to 1011-n in the input layer using predetermined weights to output signals (output values) from the s units 1121-1 to 1121-s in the recurrent layer and output output values, which are acquired by inputting the signals (values) as the addition results to the activation functions of the units 1021-1 to 1021-m, to the units 1031-1 to 1031-r in the output layer. The product-sum operation is performed from the output of the input layer and the input of the hidden layer. For example, the weights may be different for the units 1011-0 to 1011-n in the input layer or may be different by the units 1021-1 to 1021-m in the hidden layer.

The unit 1021-0 in the hidden layer outputs an output value which is acquired by inputting a signal (a value), which is a result of addition of a predetermined signal (value) to an output signal (an output value) from the unit 1121-0 in the recurrent layer, to the activation function of the unit 1021-0.

The units 1031-1 to 1031-r in the output layer output output values which are acquired by inputting signals (values) which are results of a product-sum operation which is performed on output signals (output values) from the (m+1) units 1021-0 to 1021-m in the hidden layer using predetermined weights to the activation functions of the units 1031-1 to 1031-r. The product-sum operation is performed from the output of the hidden layer to the output of the output layer. For example, the weights may be different for the units 1021-0 to 1021-m in the hidden layer or may be different for the units 1031-1 to 1031-r in the output layer.

Here, for example, signals which are acquired by copying the output signals (the output values) of the units 1021-0 to 1021-m in the hidden layer in the forward coupling may be used as the output signals (the output values) of the units 1111-0 to 1111-s in the hidden layer in the recurrent coupling. For example, the units 1111-0 to 1111-s in the hidden layer in the recurrent coupling and the units 1021-0 to 1021-m in the hidden layer in the forward coupling may be common partially or wholly, and all the units may be common particularly when s=m is satisfied as in the embodiments.

The units 1121-0 to 1121-s in the recurrent layer output output values, which are acquired by inputting signals (values) which are results of a product-sum operation which is performed on output signals (output values) from the (s+1) units 1111-0 to 1111-s in the hidden layer in the recurrent coupling using predetermined weights to the activation functions of the units 1121-0 to 1121-s, to the units 1021-0 to 1021-s in the hidden layer in the forward coupling. The product-sum operation is performed from the output of the hidden layer to the output of the recurrent layer in the recurrent coupling. For example, the weights may be different by the units 1111-0 to 1111-s in the hidden layer in the recurrent coupling or may be different by the units 1121-0 to 1121-s in the recurrent layer.

Here, the output signals from the units 1121-0 to 1121-s in the recurrent layer are output as signals of recurrence to the units 1021-0 to 1021-m in the hidden layer in the forward coupling.

In the embodiments, in the forward coupling, a configuration of a neural network in which signals are output from the units in a previous-stage layer to all the units (other than the unit of a bias term with a fixed value) in a subsequent-stage layer is described, but other configurations may be used. In the example shown in FIG. 9, in the forward coupling, signals are output from the units 1011-0 to 1011-n in the input layer to all the m units 1021-1 to 1021-m in the hidden layer and signals are output from the units 1021-0 to 1021-m in the hidden layer to all the r units 1031-1 to 1031-r in the output layer.

In the embodiments, in the recurrent coupling, a configuration of a neural network in which signals are output from the units in a previous-stage layer to all the units (other than the unit of a bias term with a fixed value) in a subsequent-stage layer is described, but other configurations may be used. In the example shown in FIG. 9, signals are output from the units 1111-0 to 1111-s in the hidden layer in the recurrent coupling to all the (s+1) units 1121-0 to 1121-s in the recurrent layer.

Here, the array unit 1001 of the neural network may process various data.

For example, the array unit 1001 may receive data of an image and output information of an identification result (identification result data) of the input data of an image.

For example, the image may be an image including 784 pixels (0-th to 783-th pixels). In this case, the number of units (n) in the input layer corresponding to the image is 784.

In the example shown in FIG. 9, the information of an identification result is r pieces of information which are output from the output layer.

When a neural network including a plurality of layers is configured, weights corresponding to between the layers (for example, between the first and second layers and between the second and third layers) may be configured, for example, using different arrays by between the layers (for example, arrays including arrangement of a plurality of neuromorphic elements by between the layers), or a configuration in which a group of arrays (for example, a group of arrays including an arrangement of a plurality of neuromorphic elements) is virtually divided by a time difference (time division) or the like and weights corresponding to two or more interlayers are implemented may be used. A configuration in which a group of arrays is spatially divided into a plurality of sub arrays and weights corresponding to two or more interlayers are implemented may be used. Similarly, one neuromorphic element may be used, for example, to correspond to one weight or may be virtually divided by a time difference (time division) or the like and be used to correspond to two or more weights.

FIG. 10 is a block diagram schematically showing a flow of signals in an array unit 2001 in a recurrent neural network system.

An array unit 2001 roughly includes an input layer 2011, a hidden layer 2012, an output layer 2013, and a recurrent layer 2021.

In the array unit 2001, in forward coupling, weighting (weighting of a first layer) and summing are performed on an input value from the input layer 2011 to the hidden layer 2012, the result of addition of a result of the summing and an output value from the recurrent layer 2021 is input to a predetermined activation function f( ), and an output value from the activation function f( ) is output from the hidden layer 2012. In the forward coupling, weighting (weighting of a second layer) and summing are performed on the output value of the hidden layer 2012 from the hidden layer 2012 to the output layer 2013, the result of the summing is input to a predetermined activation function g( ), and an output value from the activation function g( ) is output from the output layer 2013. In recurrent coupling, an output value from the recurrent layer 2021 is acquired on the basis of the output value from the hidden layer 2012 in the forward coupling, and the output value is returned to the hidden layer 2012 in the forward coupling.

The activation functions f( ) of units in the hidden layer 2012 in the forward coupling may be, for example, different by the units or may be the same by two or more units.

Similarly, the activation functions go of units in the output layer 2013 may be, for example, different by the units or may be the same by two or more units.

Here, in the array unit 2001, for the purpose of convenience of description, a part including the input layer 2011 and the weighting of the first layer is referred to as an input weighting unit 3021, a part including the recurrent layer 2021 is referred to as a recurrent layer unit 3022, and a part including the activation function f( ) in the hidden layer 2012 in the forward coupling is referred to as an activation function unit 3023.

Equation (1) represents output values yⱼ^{t} from the units in the hidden layer 2012 in the forward coupling. Here, uⱼ^{t} is an input value to the activation function f( ) in the activation function unit 3023 and represents a sum of a value Q1 from the input weighting unit 3021 in the forward coupling and a value Q2 from the recurrent layer unit 3022.

$$\begin{matrix}[ Math . 1 ] & \\ \begin{matrix}{y}_{j}^{t} = f ( {u}_{j}^{t} ) \\ = f ( Q 1 + Q 2 )\end{matrix} \\ Q 1 = {\sum }_{i} {w}_{ji}^{( L )} {x}_{i}^{t} \\ Q 2 = {\sum }_{{j}^{′}} {w}_{{jj}^{′}}^{( r )} {y}_{{j}^{′}}^{t - 1} & ( 1 )\end{matrix}$$

In Equation (1), xᵢ^{t} represents a value which is output from an i-th (where i=0, 1, 2, . . . , n) unit 1011-i of the input layer at time t. In addition, w^{(L)}_{j,i} represents a value of a weight which is multiplied when a value output from the i-th (where i=0, 1, 2, . . . , n) unit 1011-i of the input layer is input to the j-th unit 1021-j of the hidden layer in weighting of an L-th layer (where L=1 is set). w^{(L)}_{j,i} represents a value of a weight which is multiplied when a value output from the j′(=e)-th unit 1121-j′ of the recurrent layer is input to the j-th unit 1021-j of the hidden layer. Σ associated with Q1 represents the sum with respect to i. Σ associated with Q2 represents the sum with respect to j′. uⱼ^{t} represents a sum (Q1+Q2) of the values of the results of the product-sum operation in the j-th unit 1021-j of the hidden layer at time t. f(uⱼ^{t}) represents a value of a result which is acquired when uⱼ^{t} is substituted into a predetermined activation function f( ). yⱼ^{t} corresponding to the value represents a value which is output from the j-th unit 1021-j of the hidden layer at time t.

Here, for the purpose of convenience of description, it is assumed that time t increases by 1. In this case, for example, a discrete interval of time t which increases by 1 can be understood to be a clock interval. Data by time t can also be understood to be data in discrete unit times (in units of discrete times).

When a recurrent type configuration is used, for example, signals having a temporal context are used as signals which are processed therein.

Information which is delayed by an arbitrary time may be used as recurrent information for the recurrent type configuration and, for example, information of a time (t-Td) which is delayed by an arbitrary time Td (Td>0) with respect to a signal at new time t may be used as recurrent information.

For example, information which is delayed by a constant time (one type of time) may be used as recurrent information for the recurrent type configuration, or information which is delayed by a plurality of different times (two or more types of times) may be used.

### First Embodiment

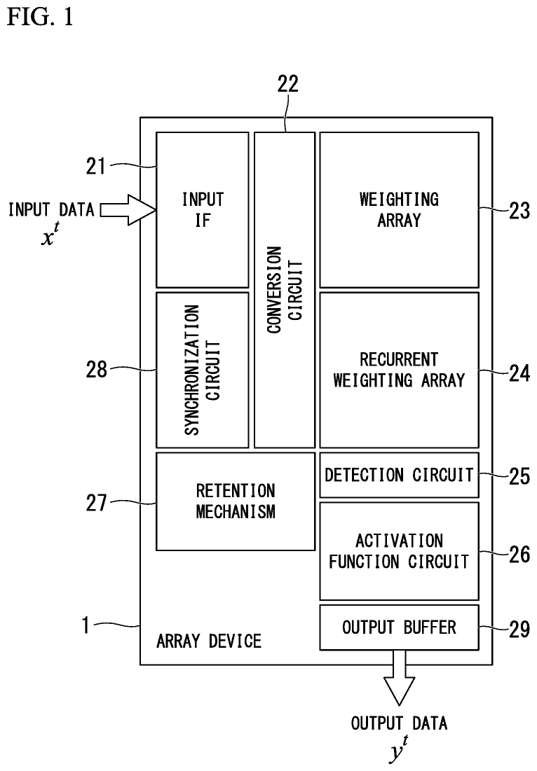

FIG. 1 is a diagram schematically showing a configuration of an array device 1 according to an embodiment (a first embodiment) of the invention.

In this embodiment, the array device 1 corresponds to an array unit of an L-th layer in a neural network. In this embodiment, a case of L=1 will be described, but the same is true of L which is equal to or greater than 2.

The array device 1 includes an input interface (an input IF) 21, a conversion circuit 22, a weighting array 23, a recurrent weighting array 24, a detection circuit 25, an activation function circuit (a neuron circuit) 26, a retention mechanism 27, a synchronization circuit 28, and an output buffer 29.

An example of such arrangement is shown in FIG. 1.

Here, for the purpose of convenience of description, a direction of one side (and the opposite side) of a rectangle (which may be a square) is defined as a vertical direction, two opposite directions of the vertical direction are defined as being upward and downward, a direction of one side (and the opposite side) perpendicular thereto is defined as a horizontal direction, and two opposite directions of the horizontal direction are defined as being rightward and leftward.

In the array device 1 of the example shown in FIG. 1, the upper input interface 21 and the lower synchronization circuit 28 are arranged and disposed in the vertical direction, and the conversion circuit 22 is arranged and disposed on the right side in the horizontal direction. The upper weighting array 23 and the lower recurrent weighting array 24 are arranged and disposed in the vertical direction, and these are arranged and disposed on the right side of the conversion circuit 22. The retention mechanism 27 is arranged and disposed below the synchronization circuit 28 and the conversion circuit 22. The detection circuit 25, the activation function circuit 26, and the output buffer 29 are sequentially arranged and disposed below the recurrent weighting array 24.

The arrangement of the example shown in FIG. 1 is schematic. The invention is not limited to the example shown in FIG. 1, and various arrangements may be used.

The input interface 21 is a circuit of an interface that receives a signal (for example, a value of data) from the outside. The input interface 21 outputs the input signal to the conversion circuit 22. In the first layer, for example, the input interface 21 receives a signal of data which is input from the outside of the neural network to the neural network.

In the second layer or layers subsequent thereto, the input interface 21 receives a signal of data output from the previous-stage layer.

The conversion circuit 22 converts the signal input from the input interface 21 into a signal which can be processed in the weighting array 23. Then, the conversion circuit 22 outputs the converted signal to the weighting array 23.

The conversion circuit 22 converts a signal input from the synchronization circuit 28 into a signal which can be processed in the recurrent weighting array 24. Then, the conversion circuit 22 outputs the converted signal to the recurrent weighting array 24.

The weighting array 23 is an array that performs a product-sum operation using a weight of the L-th layer (L=1 in this embodiment) in forward coupling. The weighting array 23 performs a pre-designed product-sum operation on the basis of the signal input from the conversion circuit 22 and the weight set by an external control unit (not shown). Then, the weighting array 23 outputs a signal which is the result of the product-sum operation to the recurrent weighting array 24.

When the example shown in FIG. 9 is referred to for the purpose of convenience of description, the weighting array 23 of the first layer corresponds to an array that performs a product-sum operation between the input layer and the hidden layer in the forward coupling shown in FIG. 9.

The recurrent weighting array 24 is an array that performs a product-sum operation based on a weight of the recurrent layer in recurrent coupling. The recurrent weighting array 24 performs a pre-designed product-sum operation on the basis of the signal input from the conversion circuit 22 and a weight set by an external control unit (not shown), and adds a signal which is the result of the product-sum operation to a signal which is the result of the product-sum operation input from the weighting array 23. Then, the recurrent weighting array 24 outputs a signal which is the result of the addition to the detection circuit 25.

When the example shown in FIG. 9 is referred to for the purpose of convenience of description, the recurrent weighting array 24 corresponds to an array that performs a product-sum operation between the hidden layer and the recurrent layer in recurrent coupling shown in FIG. 9, an operation (for example, an operation of an activation function when the activation function is used in the recurrent coupling) of an output signal from the recurrent layer if necessary, and addition of information in the forward coupling to information in the recurrent coupling.

Here, the weighting array 23 and the recurrent weighting array 24 perform operations corresponding to a plurality of units as shown in the example of FIG. 9.

In this embodiment, each of the weighting array 23 and the recurrent weighting array 24 includes a neuromorphic element and weights a signal using the neuromorphic element. Specifically, the neuromorphic element multiplies the input signal by a set weight value and outputs a signal which is the result of the multiplication.

For example, addition of two signals may be performed using an adder that adds (values of) the two signals in a digital manner or may be performed using a signal line or the like that adds currents of the two signals or the like in an analog manner.

The detection circuit 25 receives a signal output from the recurrent weighting array 24 and converts the input signal into a signal which can be processed in the activation function circuit 26. The detection circuit 25 outputs the converted signal to the activation function circuit 26.

The detection circuit 25 processes, for example, a digital signal (a digital value).

The activation function circuit 26 outputs a signal, which is the operation result of a predetermined activation function f( ) when the signal input from the detection circuit 25 is substituted into the activation function f( ), to the retention mechanism 27 and the output buffer 29.

Here, the array device 1 according to this embodiment has a configuration including the activation function circuit 26, but a configuration not including the activation function circuit 26 may be used in another configuration example. In this case, the signal output from the detection circuit 25 is output to the retention mechanism 27 and the output buffer 29.

The retention mechanism 27 retains (stores) a signal (a value thereof) input from the activation function circuit 26. Then, the retention mechanism 27 is controlled by the synchronization circuit 28 and outputs the retained signal (the value thereof) to the synchronization circuit 28.

Here, the retention mechanism 27 may be constituted, for example, using a memory such as a register that retains (stores) a signal (a value thereof).

The retention mechanism 27 may give a delay of an arbitrary time to a signal (a value thereof) which is read after being retained, and a delay of one unit time is given in this embodiment.

The synchronization circuit 28 controls the retention mechanism 27, reads a signal (a value thereof) retained by the retention mechanism 27, and outputs the read signal to the conversion circuit 22. In this case, the synchronization circuit 28 performs control such that the timing of a signal input from the input interface 21 to the conversion circuit 22 and the timing of a signal read from the retention mechanism 27 and input to the conversion circuit 22 have a predetermined timing relationship. As the predetermined timing relationship, a timing relationship in which the timing of a signal of recurrence from the recurrent layer in the neural network shown in FIG. 9 coincides with the timing of information of a signal which is subsequent by a predetermined time in the hidden layer in the forward coupling is used in this embodiment.

In this embodiment, the signal (the value thereof) stored in the retention mechanism 27 is input to the conversion circuit 22 via the synchronization circuit 28, but a configuration in which the signal (the value thereof) stored in the retention mechanism 27 is input to the conversion circuit 22 without passing through the synchronization circuit 28 may be used in another example.

The output buffer 29 temporarily stores a signal input from the activation function circuit 26 and outputs the stored signal to the outside.

Here, when output data y^{t} is output in response to input data x^{t} at time t, a signal y^{t-1} which is input from the retention mechanism 27 to the conversion circuit 22 is a signal which is obtained by delaying the output data y^{t}. In this embodiment, a signal y^{t-1} which is obtained by delaying time t by 1 is recurred.

In this embodiment, the array device 1 is configured to be able to output a signal (a signal which is the operation result of the activation function f( )) corresponding to a signal output from the hidden layer in the forward coupling shown in FIG. 9.

For example, when one or more circuits of the conversion circuit 22, the detection circuit 25, and the output buffer 29 may be omitted, the circuit may not be provided in the array device 1.

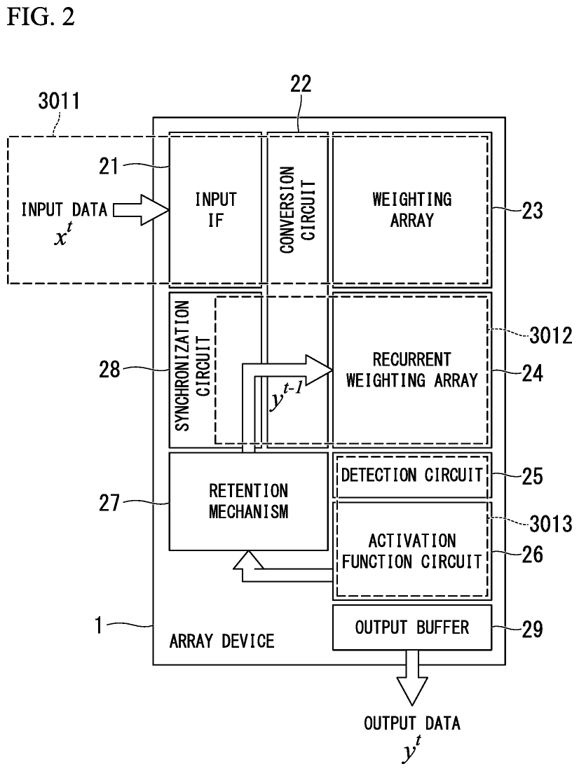

FIG. 2 is a diagram schematically showing processes in the array device 1 according to the embodiment (the first embodiment) of the invention.

In FIG. 2, the array device 1 shown in FIG. 1 is shown, and three processing units (an input weighting unit 3011, a recurrent layer unit 3012, and an activation function unit 3013) are shown for the array device 1.

The input weighting unit 3011 is a part that processes an input signal using the input interface 21, the conversion circuit 22, and the weighting array 23. The input weighting unit 3011 calculates a product-sum Q1 in Equation (1).

The recurrent layer unit 3012 is a part that processes a signal of recurrence (recurred output data) using the synchronization circuit 28, the conversion circuit 22, and the recurrent weighting array 24. The recurrent layer unit 3012 calculates a product-sum Q2 in Equation (1). In this embodiment, the recurrent layer unit 3012 has a function of adding the product-sum Q1 and the product-sum Q2.

The activation function unit 3013 is a part that processes an operation of the activation function f( ) using the detection circuit 25 and the activation function circuit 26. The activation function unit 3013 calculates a result when (Q1+Q2) is substituted into the activation function f( ) in Equation (1).

As described above, in the array device 1 according to this embodiment, a recurrent computing operation can be performed using a neuromorphic element. In the array device 1 according to this embodiment, a recurrent neural network can be simply constructed using the neuromorphic element.

In the array device 1 according to this embodiment, a constituent unit of a recurrent neural network can be implemented by mapping the weight of an input-side layer (the input layer in this embodiment) and the weight of the recurrent layer and providing a re-input mechanism.

In the array device 1 according to this embodiment, for example, the result of a product-sum operation in which a signal has been processed at a certain time and the result of a product-sum operation in which a previous signal (a time-delayed signal) has been processed can be acquired within one clock.

In this embodiment, the weighting array 23 and the recurrent weighting array 24 are constituted as independent arrays, but an area in the same array may be divided into two or more and the function of the weighting array 23 and the function of recurrent weighting array 24 may be implemented in different areas in the same array in another configuration. In this case, for example, a constituent unit of a recurrent neural network can be implemented in a small size, for example, by mapping the weight of an input-side layer (the input layer in this embodiment) and the weight of the recurrent layer on one array and providing a recurrent input mechanism.

In this way, in this embodiment, a basic configuration or signal processing of the array device 1 that performs a predetermined operation using a neuromorphic element is implemented.

For example, the array device 1 according to this embodiment includes an array (the weighting array 23 and the recurrent weighting array 24) including a neuromorphic element, a recurrent input mechanism, and a control mechanism, and it is possible to reduce peripheral circuits and to implement a basic structure of a network using a simple array by controlling the arrangement of weights of the array.

Here, for example, in a static network in which an array including a neuromorphic element is assumed to be used, it is conceivable that one plane including an input unit, an output unit, and an array is caused to correspond to a weight of one interlayer of a neural network and the array is connected to a subsequent-stage array via an activation function circuit. When a recurrent neural network is constituted in combination of such arrays, lines between peripheral circuits such as input and output circuits of the array or between arrays increase and thus a likelihood that the size will increase and design of a control circuit will be complicated is considered. In this case, since synchronization control of circuits of a plurality of arrays is performed, there is a likelihood that it may not be suitable for an increase in speed.

Accordingly, ideally, it is preferable that a basic constituent unit of a recurrent neural network be constituted using one array.

The array device 1 according to this embodiment includes a first array area (the area of the recurrent weighting array 24 in this embodiment) that includes a neuromorphic element multiplying a signal by a weight corresponding to a variable characteristic value and outputs a first signal (a signal output from the recurrent weighting array 24 in this embodiment) which is the result of processing an input signal using the neuromorphic element. The array device 1 according to this embodiment includes a retention unit (the retention mechanism 27 in this embodiment) that is able to retain the first signal (when a predetermined computing unit is not used) output from the first array area or a second signal (a signal output from the activation function circuit 26 in this embodiment) which is output when the first signal is input to a predetermined computing unit (the activation function circuit 26 in this embodiment) and inputs the retained first signal or the retained second signal to the first array area.

According to this configuration, in the array device 1 according to this embodiment, it is possible to perform recurrent processing in the array device 1 using the retention mechanism 27 and the re-input mechanism (for example, the mechanism of the synchronization circuit 28) and to construct, for example, a recurrent neural network with high extensibility of which control is easy.

Here, in the array device 1 according to this embodiment, the first array area is a recurrent array area. The predetermined computing unit performs a computing operation using a predetermined activation function.

In the array device 1 according to this embodiment, the first signal or the second signal which is input from the retention unit to the first array area is synchronized with another signal (a signal input from the weighting array 23 and a signal in response to an input signal to the array device 1) which is input to the first array area.

In the array device 1 according to this embodiment, the first signal or the second signal which is input from the retention unit to the first array area and the other signal input to the first array area are both data in discrete unit times. The other signal is a signal which is temporally subsequent to the first signal or the second signal which is input from the retention unit to the first array area.

According to this configuration, in the array device 1 according to this embodiment, it is possible to reduce an external circuit and to complete a structure for temporal re-input in the array, for example, by constructing a system synchronized with sampling of discrete signals. The discrete signals may be arbitrary signals or may be, for example, signals which are detected by an arbitrary sensor.

Here, in the array device 1 according to this embodiment, output signals (signals output from the activation function circuit 26 in this embodiment) of all the units in the hidden layer are input as signals of recurrence to the recurrent weighting array 24, but a configuration in which output signals of some units (some signals output from the activation function circuit 26 in this embodiment) in the hidden layer are input as signals of recurrence to the recurrent weighting array 24 may be used in another example. For example, a configuration in which a unit that inputs an output signal of a unit as a signal of recurrence to the recurrent weighting array 24 and a unit not performing such recurrence can be switched to each other among a plurality of units in the hidden layer may be used. Such switching may be manually performed by a user or may be automatically performed by a control unit (not shown) in accordance with a predetermined rule.

According to this configuration, in the array device 1, it is possible to cause only output signals from some units in a recurrent mechanism to recur and, for example, to dynamically reconstruct an array device which is specialized in identification of applications.

### Second Embodiment

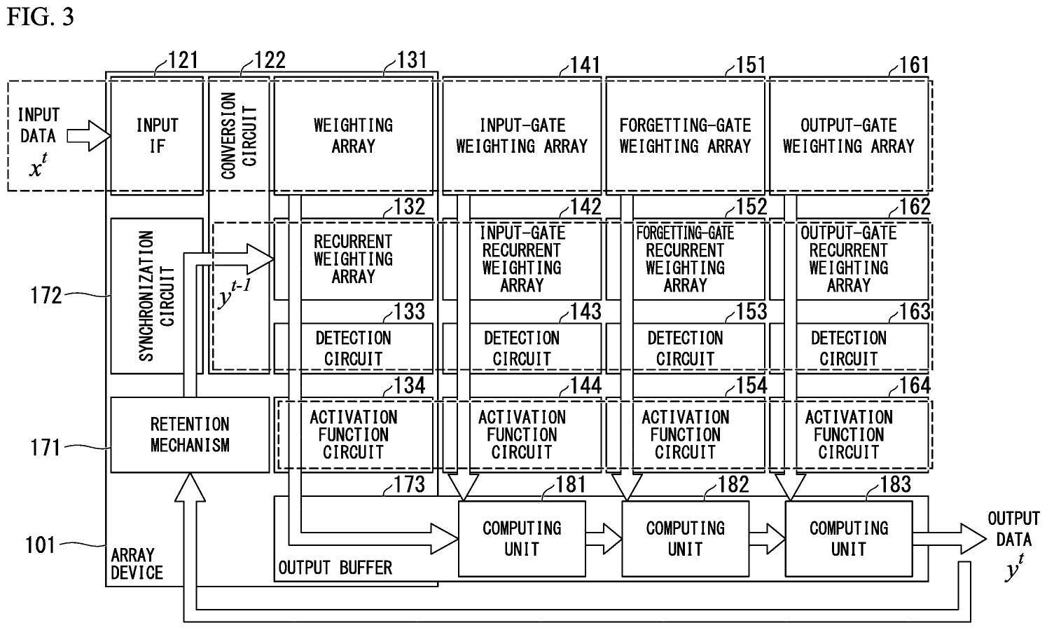

FIG. 3 is a diagram schematically showing a configuration of an array device 101 according to an embodiment (a second embodiment) of the invention.

In this embodiment, the array device 101 corresponds to an array unit of an L-th layer in a neural network. In this embodiment, a case of L=1 will be described, but the same is true of L which is equal to or greater than 2.

The array device 101 includes an input interface (an input IF) 121, a conversion circuit 122, a weighting array 131, a recurrent weighting array 132, a detection circuit 133, an activation function circuit 134, an input-gate weighting array 141, an input-gate recurrent weighting array 142, a detection circuit 143, an activation function circuit 144, a forgetting-gate weighting array 151, a forgetting-gate recurrent weighting array 152, a detection circuit 153, an activation function circuit 154, an output-gate weighting array 161, an output-gate recurrent weighting array 162, a detection circuit 163, an activation function circuit 164, a retention mechanism 171, a synchronization circuit 172, and an output buffer 173.

The output buffer 173 includes a computing unit 181, a computing unit 182, and a computing unit 183.

In this embodiment, the output buffer 173 includes the computing units 181 to 183, but a configuration in which the output buffer 173 and the computing units 181 to 183 are separate may be used in another example.

An example of such arrangement is shown in FIG. 3.

Here, for the purpose of convenience of description, a direction of one side (and the opposite side) of a rectangle (which may be a square) is defined as a vertical direction, two opposite directions of the vertical direction are defined as being upward and downward, a direction of one side (and the opposite side) perpendicular thereto is defined as a horizontal direction, and two opposite directions of the horizontal direction are defined as being rightward and leftward.

In the array device 101 of the example shown in FIG. 3, the upper input interface 121 and the lower synchronization circuit 172 are arranged and disposed in the vertical direction, and the conversion circuit 122 is arranged and disposed on the right side in the horizontal direction. The weighting array 131, the recurrent weighting array 132, and the detection circuit 133 are arranged and disposed from up to down in the vertical direction, the input-gate weighting array 141, the input-gate recurrent weighting array 142, and the detection circuit 143 are arranged and disposed from up to down in the vertical direction, the forgetting-gate weighting array 151, the forgetting-gate recurrent weighting array 152, and the detection circuit 153 are arranged and disposed from up to down in the vertical direction, the output-gate weighting array 161, the output-gate recurrent weighting array 162, and the detection circuit 163 are arranged and disposed from up to down in the vertical direction, and these are sequentially arranged and disposed on the right side of the conversion circuit 122 in the horizontal direction. The retention mechanism 171 is arranged and disposed below the synchronization circuit 172 and the conversion circuit 122 in the vertical direction. The activation function circuit 134 is arranged and disposed below the detection circuit 133 in the vertical direction. The activation function circuit 144 is arranged and disposed below the detection circuit 143 in the vertical direction, the activation function circuit 154 is arranged and disposed below the detection circuit 153 in the vertical direction, the activation function circuit 164 is arranged and disposed below the detection circuit 163 in the vertical direction, and these are sequentially arranged and disposed on the right side of the retention mechanism 171 in the horizontal direction. The output buffer 173 is arranged and disposed below the four activation function circuits 134, 144, 154, and 164 in the vertical direction. In the output buffer 173, the computing unit 181 is disposed below the activation function circuit 144, the computing unit 182 is disposed below the activation function circuit 154, and the computing unit 183 is disposed below the activation function circuit 164.

The arrangement of the example shown in FIG. 3 is schematic. The invention is not limited to the example shown in FIG. 3, and various arrangements may be used.

The array device 101 is substantially different from the array device 1 according to the first embodiment in that a plurality of combinations of an array for weighting and an array for recurrence are provided. In the array device 101, when a direction in which the array for weighting and the array for recurrence in each combination are arranged is defined as a vertical direction and a direction in which the combinations are arranged is defined as a horizontal direction for the purpose of convenience of description as described above, it can be understood that a plurality of arrays are two-dimensionally arranged in the vertical direction and the horizontal direction (where the vertical direction and the horizontal direction may be defined reversely).

In this embodiment, for example, the array device 101 which is applied to the LSTM is described.

The input interface 121 is a circuit of an interface that receives a signal (for example, a value of data) from the outside. In the first layer, the input interface 121 receives a signal of data which is input from the outside of the neural network to the neural network.

In the second layer or layers subsequent thereto, the input interface 121 receives a signal of data output from the previous-stage layer.

The conversion circuit 122 converts the signal input from the input interface 121 into a signal which can be processed in the weighting array 131, the input-gate weighting array 141, the forgetting-gate weighting array 151, and the output-gate weighting array 161. Then, the conversion circuit 122 outputs the converted signal to the weighting array 131, the input-gate weighting array 141, the forgetting-gate weighting array 151, and the output-gate weighting array 161.

Here, in this embodiment, signals which are processed in the weighting array 131, the input-gate weighting array 141, the forgetting-gate weighting array 151, and the output-gate weighting array 161 are assumed to be the same. In this embodiment, the signal which is supplied from the conversion circuit 122 to the weighting array 131 is transmitted via a common line in the weighting array 131, the input-gate weighting array 141, the forgetting-gate weighting array 151, and the output-gate weighting array 161.

The conversion circuit 122 converts a signal input from the synchronization circuit 172 into a signal which can be processed in the recurrent weighting array 132, the input-gate recurrent weighting array 142, the forgetting-gate recurrent weighting array 152, and the output-gate recurrent weighting array 162. Then, the conversion circuit 122 outputs the converted signal to the recurrent weighting array 132, the input-gate recurrent weighting array 142, the forgetting-gate recurrent weighting array 152, and the output-gate recurrent weighting array 162.

Here, in this embodiment, signals which are processed in the recurrent weighting array 132, the input-gate recurrent weighting array 142, the forgetting-gate recurrent weighting array 152, and the output-gate recurrent weighting array 162 are assumed to be the same. In this embodiment, the signal which is supplied from the conversion circuit 122 to the recurrent weighting array 132 is transmitted via a common line in the recurrent weighting array 132, the input-gate recurrent weighting array 142, the forgetting-gate recurrent weighting array 152, and the output-gate recurrent weighting array 162.

The weighting array 131 is an array that performs a product-sum operation using a weight of the L-th layer (L=1 in this embodiment) in forward coupling. The weighting array 131 performs a pre-designed product-sum operation on the basis of the signal input from the conversion circuit 122 and the weight set by an external control unit (not shown). Then, the weighting array 131 outputs a signal which is the result of the product-sum operation to the recurrent weighting array 132.

The recurrent weighting array 132 is an array that performs a product-sum operation based on a weight of the recurrent layer in recurrent coupling. The recurrent weighting array 132 performs a pre-designed product-sum operation on the basis of the signal input from the conversion circuit 122 and a weight set by an external control unit (not shown), and adds a signal which is the result of the product-sum operation to a signal which is the result of the product-sum operation input from the weighting array 131. Then, the recurrent weighting array 132 outputs a signal which is the result of the addition to the detection circuit 133.

When the example shown in FIG. 9 is referred to for the purpose of convenience of description, the recurrent weighting array 132 corresponds to an array that performs a product-sum operation between the hidden layer and the recurrent layer in recurrent coupling shown in FIG. 9, an operation (for example, an operation of an activation function when the activation function is used in the recurrent coupling) of an output signal from the recurrent layer if necessary, and addition of information in the forward coupling to information in the recurrent coupling.

Here, the weighting array 131 and the recurrent weighting array 132 perform operations corresponding to a plurality of units as shown in the example of FIG. 9.

In this embodiment, each of the weighting array 131 and the recurrent weighting array 132 includes a neuromorphic element and weights a signal using the neuromorphic element. Specifically, the neuromorphic element multiplies the input signal by a set weight value and outputs a signal which is the result of the multiplication.

For example, addition of two signals may be performed using an adder that adds (values of) the two signals in a digital manner or may be performed using a signal line or the like that adds currents of the two signals or the like in an analog manner.

The input-gate weighting array 141 is an array that performs a product-sum operation based on a weight of an input gate in the LSTM. The input-gate weighting array 141 performs a pre-designed product-sum operation on the basis of the signal input from the conversion circuit 122 and a weight set by an external control unit (not shown). Then, the input-gate weighting array 141 outputs a signal which is the result of the product-sum operation to the input-gate recurrent weighting array 142.

The input-gate recurrent weighting array 142 is an array that performs a product-sum operation based on a weight of the recurrent layer in the input gate in the LSTM. The input-gate recurrent weighting array 142 performs a pre-designed product-sum operation on the basis of the signal input from the conversion circuit 122 and a weight set by an external control unit (not shown), and adds a signal which is the result of the product-sum operation to a signal which is the result of the product-sum operation input from the input-gate weighting array 141. Then, the input-gate recurrent weighting array 142 outputs a signal which is the result of the addition to the detection circuit 143.

The input-gate recurrent weighting array 142 is associated with the input gate and corresponds to an array that performs a product-sum operation between the hidden layer and the recurrent layer in recurrent coupling, an operation (for example, an operation of an activation function when the activation function is used in the recurrent coupling) of an output signal from the recurrent layer if necessary, and addition of information in the forward coupling to information in the recurrent coupling.

Here, the input-gate weighting array 141 and the input-gate recurrent weighting array 142 perform operations corresponding to a plurality of units as shown in the example of FIG. 9.

In this embodiment, each of the input-gate weighting array 141 and the input-gate recurrent weighting array 142 includes a neuromorphic element and weights a signal using the neuromorphic element. Specifically, the neuromorphic element multiplies the input signal by a set weight value and outputs a signal which is the result of the multiplication.

For example, addition of two signals may be performed using an adder that adds (values of) the two signals in a digital manner or may be performed using a signal line or the like that adds currents of the two signals or the like in an analog manner.

The forgetting-gate weighting array 151 is an array that performs a product-sum operation based on a weight of a forgetting gate in the LSTM. The forgetting-gate weighting array 151 performs a pre-designed product-sum operation on the basis of the signal input from the conversion circuit 122 and a weight set by an external control unit (not shown). Then, the forgetting-gate weighting array 151 outputs a signal which is the result of the product-sum operation to the forgetting-gate recurrent weighting array 152.

The forgetting-gate recurrent weighting array 152 is an array that performs a product-sum operation based on a weight of the recurrent layer in the forgetting gate in the LSTM. The forgetting-gate recurrent weighting array 152 performs a pre-designed product-sum operation on the basis of the signal input from the conversion circuit 122 and a weight set by an external control unit (not shown), and adds a signal which is the result of the product-sum operation to a signal which is the result of the product-sum operation input from the forgetting-gate weighting array 151. Then, the forgetting-gate recurrent weighting array 152 outputs a signal which is the result of the addition to the detection circuit 153.

The forgetting-gate recurrent weighting array 152 is associated with the forgetting gate and corresponds to an array that performs a product-sum operation between the hidden layer and the recurrent layer in recurrent coupling, an operation (for example, an operation of an activation function when the activation function is used in the recurrent coupling) of an output signal from the recurrent layer if necessary, and addition of information in the forward coupling to information in the recurrent coupling.

Here, the forgetting-gate weighting array 151 and the forgetting-gate recurrent weighting array 152 perform operations corresponding to a plurality of units as shown in the example of FIG. 9.

In this embodiment, each of the forgetting-gate weighting array 151 and the forgetting-gate recurrent weighting array 152 includes a neuromorphic element and weights a signal using the neuromorphic element. Specifically, the neuromorphic element multiplies the input signal by a set weight value and outputs a signal which is the result of the multiplication.

For example, addition of two signals may be performed using an adder that adds (values of) the two signals in a digital manner or may be performed using a signal line or the like that adds currents of the two signals or the like in an analog manner.

The output-gate weighting array 161 is an array that performs a product-sum operation based on a weight of an output gate in the LSTM. The output-gate weighting array 161 performs a pre-designed product-sum operation on the basis of the signal input from the conversion circuit 122 and a weight set by an external control unit (not shown). Then, the output-gate weighting array 161 outputs a signal which is the result of the product-sum operation to the output-gate recurrent weighting array 162.

The output-gate recurrent weighting array 162 is an array that performs a product-sum operation based on a weight of the recurrent layer in the output gate in the LSTM. The output-gate recurrent weighting array 162 performs a pre-designed product-sum operation on the basis of the signal input from the conversion circuit 122 and a weight set by an external control unit (not shown), and adds a signal which is the result of the product-sum operation to a signal which is the result of the product-sum operation input from the output-gate weighting array 161. Then, the output-gate recurrent weighting array 162 outputs a signal which is the result of the addition to the detection circuit 163.

The output-gate recurrent weighting array 162 is associated with the output gate and corresponds to an array that performs a product-sum operation between the hidden layer and the recurrent layer in recurrent coupling, an operation (for example, an operation of an activation function when the activation function is used in the recurrent coupling) of an output signal from the recurrent layer if necessary, and addition of information in the forward coupling to information in the recurrent coupling.

Here, the output-gate weighting array 161 and the output-gate recurrent weighting array 162 perform operations corresponding to a plurality of units as shown in the example of FIG. 9.

In this embodiment, each of the output-gate weighting array 161 and the output-gate recurrent weighting array 162 includes a neuromorphic element and weights a signal using the neuromorphic element. Specifically, the neuromorphic element multiplies the input signal by a set weight value and outputs a signal which is the result of the multiplication.

For example, addition of two signals may be performed using an adder that adds (values of) the two signals in a digital manner or may be performed using a signal line or the like that adds currents of the two signals or the like in an analog manner.

The detection circuit 133 receives a signal output from the recurrent weighting array 132 and converts the input signal into a signal which can be processed in the activation function circuit 134. Then, the detection circuit 133 outputs the converted signal to the activation function circuit 134.

The detection circuit 143 receives a signal output from the input-gate recurrent weighting array 142 and converts the input signal into a signal which can be processed in the activation function circuit 144. Then, the detection circuit 143 outputs the converted signal to the activation function circuit 144.

The detection circuit 153 receives a signal output from the forgetting-gate recurrent weighting array 152 and converts the input signal into a signal which can be processed in the activation function circuit 154. Then, the detection circuit 153 outputs the converted signal to the activation function circuit 154.

The detection circuit 163 receives a signal output from the output-gate recurrent weighting array 162 and converts the input signal into a signal which can be processed in the activation function circuit 164. Then, the detection circuit 163 outputs the converted signal to the activation function circuit 164.

The detection circuits 133, 143, 153, and 163 process, for example, a digital signal (a digital value).

The activation function circuit 134 outputs a signal, which is the operation result of a predetermined activation function f( ) when the signal input from the detection circuit 133 is substituted into the activation function f( ), to the output buffer 173.

The activation function circuit 144 outputs a signal, which is the operation result of a predetermined activation function f( ) when the signal input from the detection circuit 143 is substituted into the activation function f( ), to the output buffer 173.

The activation function circuit 154 outputs a signal, which is the operation result of a predetermined activation function f( ) when the signal input from the detection circuit 153 is substituted into the activation function f( ), to the output buffer 173.

The activation function circuit 164 outputs a signal, which is the operation result of a predetermined activation function f( ) when the signal input from the detection circuit 163 is substituted into the activation function f( ), to the output buffer 173.

The activation function f( ) may differ depending on the activation function circuits 134, 144, 154, and 164.

Here, the array device 101 according to this embodiment has a configuration including the activation function circuits 134, 144, 154, and 164, but a configuration not including the activation function circuits 134, 144, 154, and 164 may be used in another configuration example. In this case, the signals output from the detection circuits 133, 143, 153, and 163 is output to the output buffer 173.

The retention mechanism 171 retains (stores) a signal (a value thereof) input from the output buffer 173. Then, the retention mechanism 171 is controlled by the synchronization circuit 172 and outputs the retained signal (the value thereof) to the synchronization circuit 172.

Here, the retention mechanism 171 may be constituted, for example, using a memory such as a register that retains (stores) a signal (a value thereof).

The retention mechanism 171 may give a delay of an arbitrary time to a signal (a value thereof) which is read after being retained, and a delay of one unit time is given in this embodiment.

The synchronization circuit 172 controls the retention mechanism 171, reads a signal (a value thereof) retained by the retention mechanism 171, and outputs the read signal to the conversion circuit 122. In this case, the synchronization circuit 172 performs control such that the timing of a signal input from the input interface 121 to the conversion circuit 122 and the timing of a signal read from the retention mechanism 171 and input to the conversion circuit 122 have a predetermined timing relationship. As the predetermined timing relationship, a timing relationship in which the timing of a signal of recurrence from the recurrent layer in the neural network in the LSTM coincides with the timing of information of a signal which is subsequent by a predetermined time in the hidden layer in the forward coupling is used in this embodiment.

In this embodiment, the signal (the value thereof) stored in the retention mechanism 171 is input to the conversion circuit 122 via the synchronization circuit 172, but a configuration in which the signal (the value thereof) stored in the retention mechanism 171 is input to the conversion circuit 122 without passing through the synchronization circuit 172 may be used in another example.

The output buffer 173 temporarily stores signals input from the four activation function circuits 134, 144, 154, and 164 and outputs a signal which is the result of computing based on the stored signal to the outside.

Here, when output data y^{t} is output in response to input data x^{t} at time t, a signal y^{t-1} which is input from the retention mechanism 171 to the conversion circuit 122 is a signal which is obtained by delaying the output data y^{t}. In this embodiment, a signal y″ which is obtained by delaying time t by 1 is recurred.

The output buffer 173 performs a computing operation on the signals output from the four activation function circuits 134, 144, 154, and 164 using three computing units 181 to 183 and outputs signals which are the results of the computing operation.

Here, the computing unit 181 performs, for example, multiplication or addition.

For example, the computing unit 181 multiplies the signal input from the activation function circuit 134 by the signal input from the activation function circuit 144 and outputs a signal which is the multiplication result to the computing unit 182.

The computing unit 182 adds the signal input from the computing unit 181 to the signal input from the activation function circuit 154 and outputs a signal which is the addition result to the computing unit 183.

The computing unit 183 multiplies the signal input from the computing unit 182 by the signal input from the activation function circuit 164 and outputs a signal which is the multiplication result. This signal is a signal which is output from the output buffer 173.

In this embodiment, when one or more circuits of the conversion circuit 122, the detection circuits 133, 143, 153, and 163, and the output buffer 173 (a part other than the functions of the three computing units 181 to 183 herein) may be omitted, the corresponding circuit may not be provided in the array device 101.

As described above, in the array device 101 according to this embodiment, a recurrent computing operation can be performed using a neuromorphic element. In the array device 101 according to this embodiment, a recurrent neural network can be simply constructed using the neuromorphic element.

In the array device 101 according to this embodiment includes coupling ports of a plurality of different systems (a system of the weighting array 131, a system of the input-gate weighting array 141, a system of the forgetting-gate weighting array 151, and a system of the output-gate weighting array 161) in the neural network in parallel, and can cause the signals which are the processing results in the plurality of systems to recur by the computing operations in the computing units 181 to 183.

The array device 101 according to this embodiment includes a first array area (the area of the recurrent weighting array 132, the area of the input-gate recurrent weighting array 142, the area of the forgetting-gate recurrent weighting array 152, and the area of the output-gate recurrent weighting array 162 in this embodiment) that includes a neuromorphic element multiplying a signal by a weight corresponding to a variable characteristic value and outputs a first signal (signals output from the recurrent weighting array 132, the input-gate recurrent weighting array 142, the forgetting-gate recurrent weighting array 152, and the output-gate recurrent weighting array 162 in this embodiment) which is the result of processing an input signal using the neuromorphic element. The array device 101 according to this embodiment includes a retention unit (the retention mechanism 171 in this embodiment) that is able to retain the first signal (when a predetermined computing unit is not used) output from the first array area or a second signal (a signal output from the computing unit 183 in this embodiment) which is output when the first signal is input to a predetermined computing unit (the activation function circuits 134, 144, 154, and 164 and the computing units 181 to 183 in this embodiment) and inputs the retained first signal or the retained second signal to the first array area.

According to this configuration, in the array device 101 according to this embodiment, it is possible to perform recurrent processing in the array device 101 using the retention mechanism 171 and the re-input mechanism (for example, the mechanism of the synchronization circuit 172) and to construct, for example, a recurrent neural network with high extensibility of which control is easy.

In the array device 101 according to this embodiment, the first signal or the second signal which is input from the retention unit to the first array area is synchronized with another signal (signals input from the weighting array 131, the input-gate weighting array 141, the forgetting-gate weighting array 151, and the output-gate weighting array 161 and signals in response to an input signal to the array device 101) which is input to the first array area.

In the array device 101 according to this embodiment, the first signal or the second signal which is input from the retention unit to the first array area and the other signal input to the first array area are data in discrete unit times. The other signal is a signal which is temporally subsequent to the first signal or the second signal which is input from the retention unit to the first array area.

According to this configuration, in the array device 101 according to this embodiment, it is possible to reduce an external circuit and to complete a structure for temporal re-input in the array, for example, by constructing a system synchronized with sampling of discrete signals. The discrete signals may be arbitrary signals or may be, for example, signals which are detected by an arbitrary sensor.

In the array device 101 according to this embodiment, the first array area includes a plurality of different areas (the area of the recurrent weighting array 132, the area of the input-gate recurrent weighting array 142, the area of the forgetting-gate recurrent weighting array 152, and the area of the output-gate recurrent weighting array 162 in this embodiment) including a common line, and outputs signals from the plurality of areas as the first signal. In the array device 101 according to this embodiment, the retention unit can retain the second signal which is output when the signals output from the plurality of areas of the first array area are input to the computing unit and input the retained second signal to one or more (all in this embodiment) of the plurality of areas of the first array area.

According to this configuration, in the array device 101 according to this embodiment, it is possible to simultaneously perform operations of the gates by providing a plurality of array areas in parallel. The array device 101 according to this embodiment can cope with, for example, a case in which an input signal and a recurrent signal are used in a plurality of gates such as the LSTM.

In this embodiment, the array of the input-side layer (the weighting array 131, the input-gate weighting array 141, the forgetting-gate weighting array 151, and the output-gate weighting array 161) and the recurrence-side array (the recurrent weighting array 132, the input-gate recurrent weighting array 142, the forgetting-gate recurrent weighting array 152, and the output-gate recurrent weighting array 162) are constituted as independent arrays, but a configuration in which the area of the same array is divided into two or more areas and the function of the array of the input-side layer and the function of the recurrence-side array are implemented in the different areas of the same array may be employed as another example. In this case, a constituent unit of a recurrent neural network can be implemented in a small size, for example, by mapping the weight of the input-side layer (the input layer in this embodiment) and the weight of the recurrent layer in one array and providing a re-input mechanism.

In this embodiment, four types of combinations of the array of the input-side layer and the recurrence-side array (a combination of the weighting array 131 and the recurrent weighting array 132, a combination of the input-gate weighting array 141 and the input-gate recurrent weighting array 142, a combination of the forgetting-gate weighting array 151 and the forgetting-gate recurrent weighting array 152, and a combination of the output-gate weighting array 161 and the output-gate recurrent weighting array 162) are constituted as independent arrays, but a configuration in which the area of the same array is divided into two or more areas and two or more types of combinations are implemented in the different areas of the same array may be employed as another example. In this case, a constituent unit of a recurrent neural network can be implemented in a small size, for example, by mapping the weights associated with the two or more types of combinations on one array and providing a re-input mechanism.

Here, in the array device 101 according to this embodiment, output signals (signals output from the output buffer 173 in this embodiment) of all the units in the hidden layer are input as signals of recurrence to the recurrent arrays (the recurrent weighting array 132, the input-gate recurrent weighting array 142, the forgetting-gate recurrent weighting array 152, and the output-gate recurrent weighting array 162), but a configuration in which output signals of some units (some signals output from the output buffer 173 in this embodiment) in the hidden layer are input as signals of recurrence to the recurrent arrays may be used in another example. For example, a configuration in which a unit that inputs an output signal of a unit as a signal of recurrence to the recurrent array and a unit not performing such recurrence can be switched to each other among a plurality of units in the hidden layer may be used.

By providing such switching mechanism, for example, in a neural network system in which a recurrent network layer and a forward network layer are mixed, a hierarchical structure based on the same module can be easily implemented, that is, in the same module, a part corresponding to the recurrent network layer can be switched to a recurrent type and a part corresponding to the forward network layer can be switched to a forward type (that is, a type other than the recurrent type). For example, such switching may be manually performed by a user or may be automatically performed by a control unit (not shown) in accordance with a predetermined rule.

According to this configuration, in the array device 101, it is possible to cause only output signals from some units in a recurrent mechanism to recur and, for example, to dynamically reconstruct an array device which is specialized in identification of applications.

### Third Embodiment

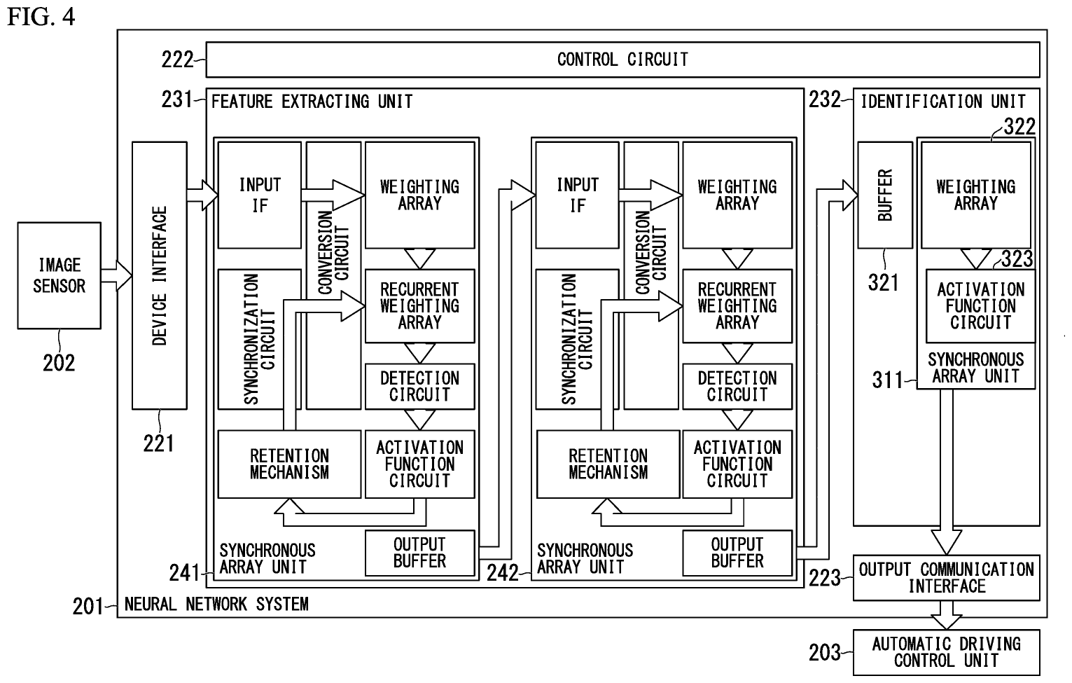

FIG. 4 is a diagram schematically showing a configuration of a neural network system 201 according to an embodiment (a third embodiment) of the invention.

In this embodiment, the neural network system 201 corresponds to an array system.

In FIG. 4, an image sensor 202 and an automatic driving control unit 203 are further shown. In this embodiment, the image sensor 202 and the automatic driving control unit 203 are mounted in a vehicle (the same vehicle) such as an automobile.

The image sensor 202 is a sensor such as a camera and includes a buffer memory (not shown).

The image sensor 202 detects data of an image (for example, captures an image) and stores the detected data of an image in the buffer memory. The data of an image is stored in the buffer memory, for example, for each frame.

The image sensor 202 outputs the data of an image stored in the buffer memory to the neural network system 201 for each frame.

The neural network system 201 performs a feature extracting process and an identification process on the data of an image input from the image sensor 202 and outputs data of the process results to the automatic driving control unit 203.

The automatic driving control unit 203 controls a vehicle such as an automobile in which the automatic driving control unit 203 is mounted on the basis of data input from the neural network system 201.

Here, in this embodiment, the data of an image detected by the image sensor 202 is input to the neural network system 201, but data input to the neural network system 201 may be arbitrary data.

In this embodiment, the data output from the neural network system 201 is input to the automatic driving control unit 203, but data output from the neural network system 201 may be input to an arbitrary device and be used therein.

The neural network system 201 includes a device interface 221, a control circuit 222, an output communication interface 223, a feature extracting unit 231, and an identification unit 232.

The feature extracting unit 231 includes two synchronous array units (array devices) 241 and 242.

Each of the synchronous array units 241 and 242 receives and processes a signal (a value of data) output from a processing unit in a previous stage and outputs the processed signal to a processing unit in a subsequent stage.

In this embodiment, the configuration and the operation of each of the synchronous array units 241 and 242 are substantially the same as the configuration and the operation of the array device 1 according to the first embodiment shown in FIG. 1. Accordingly, in this embodiment, the detailed configuration and operation of each of the synchronous array units 241 and 242 will be omitted.

In this embodiment, the synchronous array unit 241 is a processing unit of a first layer and the synchronous array unit 242 is a processing unit of a second layer.

The synchronous array unit 241 of the first layer receives and processes a signal output from the device interface 221 and outputs the processed signal to the synchronous array unit 242 of the second layer.

The synchronous array unit 242 of the second layer receives and processes a signal output from the synchronous array unit 241 of the first layer and outputs the processed signal to the identification unit 232.

Each of the synchronous array units 241 and 242 has a recurrent type configuration. Each of the synchronous array units 241 and 242 can be understood to perform a process of extracting a feature from data to be processed.

The identification unit 232 includes a synchronous array unit 311 and a buffer 321. The synchronous array unit 311 includes a weighting array 322 and an activation function circuit 323.

An example of such arrangement is shown in FIG. 4.

Here, for the purpose of convenience of description, a direction of one side (and the opposite side) of a rectangle (which may be a square) is defined as a vertical direction, two opposite directions of the vertical direction are defined as being upward and downward, a direction of one side (and the opposite side) perpendicular thereto is defined as a horizontal direction, and tow opposite directions of the horizontal direction are defined as being rightward and leftward.

In the neural network system 201 of the example shown in FIG. 4, the device interface 221, the feature extracting unit 231, and the identification unit 232 are arranged and disposed from left to right in the horizontal direction. The control circuit 222 is arranged and disposed above the feature extracting unit 231 and the identification unit 232 in the vertical direction. The output communication interface 223 is arranged and disposed below the identification unit 232 in the vertical direction. In the feature extracting unit 231, two synchronous array units 241 and 242 are arranged and disposed from left to right in the horizontal direction. In the identification unit 232, the buffer 321 and the synchronous array unit 311 are arranged and disposed from left to right in the horizontal direction. In the synchronous array unit 311, the weighting array 322 and the activation function circuit 323 are arranged and disposed from up to down in the vertical direction.

The arrangement of the example shown in FIG. 4 is schematic. The invention is not limited to the example shown in FIG. 4, and various arrangements may be used.

The buffer 321 receives a signal output from the synchronous array unit 242 in the final stage of the feature extracting unit 231, temporarily stores the input signal, and outputs the stored signal to the weighting array 322.

The weighting array 322 is an array that performs a product-sum operation using a weight of an output stage in forward coupling. The weighting array 322 performs a pre-designed product-sum operation on the basis of the signal input from the buffer 321 and the weight set by the external control circuit 222 (an example of a control unit). Then, the weighting array 322 outputs a signal which is the result of the product-sum operation to the activation function circuit 323.

When the example shown in FIG. 9 is referred to for the purpose of convenience of description, the weighting array 322 corresponds to an array that performs a product-sum operation between the hidden layer and the output layer in the forward coupling shown in FIG. 9.

Here, the weighting array 322 performs operations corresponding to a plurality of units as shown in the example of FIG. 9.

In this embodiment, the weighting array 322 includes a neuromorphic element and weights a signal using the neuromorphic element. Specifically, the neuromorphic element multiplies the input signal by a set weight value and outputs a signal which is the result of the multiplication.

For example, addition of two signals may be performed using an adder that adds (values of) the two signals in a digital manner or may be performed using a signal line or the like that adds currents of the two signals or the like in an analog manner.

The activation function circuit 323 outputs a signal, which is the operation result of a predetermined activation function f( ) when the signal input from the weighting array 322 is substituted into the activation function f( ), to the output communication interface 223.

Here, the identification unit 232 can be understood to identify data to be processed on the basis of features extracted by the feature extracting unit 231.

The activation function f( ) may differ depending on the synchronous array units 241, 242, and 311.

Here, the neural network system 201 according to this embodiment has a configuration including the activation function circuit 323, but a configuration not including the activation function circuit 323 may be used in another configuration example. In this case, the signal output from the weighting array 322 is output to the output communication interface 223.

The output communication interface 223 outputs a signal input from the activation function circuit 323 of the identification unit 232 to the external automatic driving control unit 203.

The signal (data of the identification result) output from the identification unit 232 is data on an object which appears in an image of image data input to the device interface 221 in this embodiment. In this embodiment, examples of the object include a road on which a vehicle such as an automobile is traveling, a traffic mark, a white line, a pedestrian, and an oncoming vehicle.

The control circuit 222 performs a variety of control in the neural network system 201.

The control circuit 222 includes, for example, a circuit that controls synchronization, a circuit that controls power management, a circuit that performs resetting, and a circuit that sets weights for weighting arrays and recurrent weighting arrays.

Here, the control circuit 222 may have, for example, a learning (machine learning) function in the neural network system 201. In this case, the control circuit 222 has a function of updating (computing) values of weights which are assigned to neuromorphic elements included in the arrays on the basis of information on the acquired identification result (for example, information on learning) in the neural network system 201.

The control circuit 222 sets weights (values thereof) for the neuromorphic elements included in the arrays. For example, by transmitting a predetermined signal to a neuromorphic element included in each array, the control circuit 222 may set the weight (the value thereof) corresponding to the signal for the neuromorphic element. As the predetermined signals, an arbitrary signal may be used and, for example, a signal of a voltage pulse may be used.

Here, in the example shown in FIG. 4, the feature extracting unit 231 including two synchronous array units 241 and 242 in parallel is shown, but a feature extracting unit including one synchronous array unit may be used or a feature extracting unit including three or more synchronous array units in parallel may be used in another example.

In the example shown in FIG. 4, all the synchronous array units 241 and 242 included in the feature extracting unit 231 have a recurrent type configuration, but a feature extracting unit in which some of a plurality of synchronous array units have a recurrent type configuration may be used in another example.

As described above, in the neural network system 201 according to this embodiment, processing of a neural network can be performed using an array device (the synchronous array units 241 and 242 in this embodiment) including neuromorphic elements.

### Fourth Embodiment

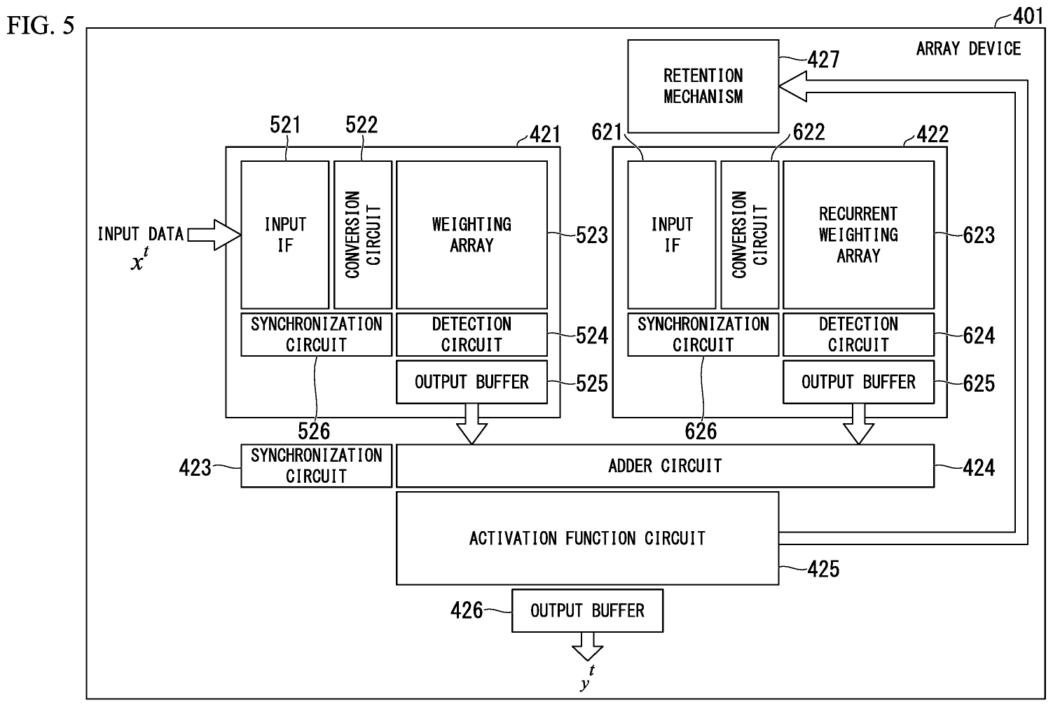

FIG. 5 is a diagram schematically showing a configuration of an array device 401 according to an embodiment (a fourth embodiment) of the invention.

In this embodiment, the array device 401 corresponds to an array unit of an L-th layer in a neural network. In this embodiment, a case of L=1 will be described, but the same is true of L which is equal to or greater than 2.

The array device 401 includes a synchronous array unit 421, a synchronous array unit 422, a synchronization circuit 423, an adder circuit 424, an activation function circuit 425, an output buffer 426, and a retention mechanism 427.

The synchronous array unit 421 includes an input interface (input IF) 521, a conversion circuit 522, a weighting array 523, a detection circuit 524, an output buffer 525, and a synchronization circuit 526.

The recurrent synchronous array unit 422 includes an input interface (input IF) 621, a conversion circuit 622, a recurrent weighting array 623, a detection circuit 624, an output buffer 625, and a synchronization circuit 626.

An example of such arrangement is shown in FIG. 5.

Here, for the purpose of convenience of description, a direction of one side (and the opposite side) of a rectangle (which may be a square) is defined as a vertical direction, two opposite directions of the vertical direction are defined as being upward and downward, a direction of one side (and the opposite side) perpendicular thereto is defined as a horizontal direction, and two opposite directions of the horizontal direction are defined as being rightward and leftward.

In the array device 401 of the example shown in FIG. 5, two synchronous array units 421 and 422 are arranged and disposed from right to left in the horizontal direction. The synchronization circuit 423 and the adder circuit 424 are arranged and disposed from right to left in the horizontal direction, and these are arranged and disposed below the two synchronous array units 421 and 422 in the vertical direction. The activation function circuit 425 is arranged and disposed below the adder circuit 424 in the vertical direction. The output buffer 426 is arranged and disposed below the activation function circuit 425 in the vertical direction. The retention mechanism 427 is arranged and disposed above the synchronous array unit 422 in the vertical direction.

In the synchronous array units 421 and 422, the input interfaces 521 and 621, the conversion circuits 522 and 622, and the arrays (the weighting array 523 and the recurrent weighting array 623) are sequentially arranged and disposed from left to right in the horizontal direction. The synchronization circuits 526 and 626 are arranged and disposed below the input interfaces 521 and 621 and the conversion circuits 522 and 622 in the vertical direction. The detection circuits 524 and 624 are arranged and disposed below the arrays (the weighting array 523 and the recurrent weighting array 623) in the vertical direction. The output buffers 525 and 625 are arranged and disposed below the detection circuits 524 and 624 in the vertical direction. The synchronization circuits 526 and 626 and the detection circuits 524 and 624 are arranged and disposed in the horizontal direction.

The arrangement of the example shown in FIG. 5 is schematic. The invention is not limited to the example shown in FIG. 5, and various arrangements may be used.

Processes which are performed in the synchronous array unit 421 will be described below.

The input interface 521 is a circuit of an interface that receives a signal (for example, a value of data) from the outside. The input interface 521 outputs the input signal to the conversion circuit 522. In the first layer, the input interface 521 receives a signal of data which is input from the outside of a neural network to the neural network.

In the second layer or layers subsequent thereto, the input interface 521 receives a signal of data output from the previous-stage layer.

The conversion circuit 522 converts the signal input from the input interface 521 into a signal which can be processed in the weighting array 523. Then, the conversion circuit 522 outputs the converted signal to the weighting array 523.

The weighting array 523 is an array that performs a product-sum operation using a weight of the L-th layer (L=1 in this embodiment) in forward coupling. The weighting array 523 performs a pre-designed product-sum operation on the basis of the signal input from the conversion circuit 522 and the weight set by an external control unit (not shown). Then, the weighting array 523 outputs a signal which is the result of the product-sum operation to the detection circuit 524.

When the example shown in FIG. 9 is referred to for the purpose of convenience of description, the weighting array 523 of the first layer corresponds to an array that performs a product-sum operation between the input layer and the hidden layer in the forward coupling shown in FIG. 9.

Here, the weighting array 523 performs operations corresponding to a plurality of units as shown in the example of FIG. 9.

In this embodiment, the weighting array 523 includes a neuromorphic element and weights a signal using the neuromorphic element. Specifically, the neuromorphic element multiplies the input signal by a set weight value and outputs a signal which is the result of the multiplication.

For example, addition of two signals may be performed using an adder that adds (values of) the two signals in a digital manner or may be performed using a signal line or the like that adds currents of the two signals or the like in an analog manner.

The detection circuit 524 receives a signal output from the weighting array 523 and converts the input signal into a signal which can be processed in a processing unit of a subsequent stage (for example, the activation function circuit 425). The detection circuit 524 outputs the converted signal to the output buffer 525.

The detection circuit 524 processes, for example, a digital signal (a digital value).

The output buffer 525 temporarily stores the signal input from the detection circuit 524 and outputs the stored signal to the adder circuit 424.

The synchronization circuit 526 performs control for synchronization of the synchronous array unit 421.

Processes which are performed in the recurrent synchronous array unit 422 will be described below.

The input interface 621 is a circuit of an interface that receives a signal (for example, a value of data) from the outside. The input interface 621 outputs the input signal to the conversion circuit 622. In this embodiment, the input interface 621 receives a signal of data which is output from the retention mechanism 427.

The conversion circuit 622 converts the signal input from the input interface 621 into a signal which can be processed in the recurrent weighting array 623. Then, the conversion circuit 622 outputs the converted signal to the recurrent weighting array 623.

The recurrent weighting array 623 is an array that performs a product-sum operation based on a weight of the recurrent layer in recurrent coupling. The recurrent weighting array 623 performs a pre-designed product-sum operation on the basis of the signal input from the conversion circuit 622 and a weight set by an external control unit (not shown). Then, the recurrent weighting array 623 outputs a signal which is the result of the product-sum operation to the detection circuit 624.

When the example shown in FIG. 9 is referred to for the purpose of convenience of description, the recurrent weighting array 623 corresponds to an array that performs a product-sum operation between the hidden layer and the recurrent layer in the recurrent coupling shown in FIG. 9.

Here, the recurrent weighting array 623 performs operations corresponding to a plurality of units as shown in the example of FIG. 9.

In this embodiment, the recurrent weighting array 623 includes a neuromorphic element and weights a signal using the neuromorphic element. Specifically, the neuromorphic element multiplies the input signal by a set weight value and outputs a signal which is the result of the multiplication.

For example, addition of two signals may be performed using an adder that adds (values of) the two signals in a digital manner or may be performed using a signal line or the like that adds currents of the two signals or the like in an analog manner.

The detection circuit 624 receives a signal output from the recurrent weighting array 623 and converts the input signal into a signal which can be processed in a processing unit of a subsequent stage (for example, the activation function circuit 425). The detection circuit 624 outputs the converted signal to the output buffer 625.

The detection circuit 624 processes, for example, a digital signal (a digital value).

The output buffer 625 temporarily stores the signal input from the detection circuit 624 and outputs the stored signal to the adder circuit 424.

The synchronization circuit 626 performs control for synchronization of the recurrent synchronous array unit 422.

Here, in the example shown in FIG. 5, the recurrent synchronous array unit 422 does not include an activation function circuit, but may include an activation function circuit in another example. For example, an activation function circuit may be provided between the detection circuit 624 and the output buffer 625. In this case, the activation function circuit receives a signal output from the detection circuit 624 and outputs a signal, which is the operation result of a predetermined activation function f( ) when the input signal is substituted into the activation function f( ), to the output buffer 625.

Processes which are performed in processing units other than the two synchronous array units 421 and 422 will be described below.

The synchronization circuit 423 performs control for timing synchronization between the forward coupling and the recurrent coupling.

For example, the synchronization circuit 423 controls the retention mechanism 427, reads a signal (a value thereof) retained by the retention mechanism 427, and outputs the read signal to the synchronous array unit 422. In this case, the synchronization circuit 423 performs control such that the timing of a signal input from the synchronous array unit 421 to the adder circuit 424 and the timing of a signal input from the recurrent synchronous array unit 422 and to the adder circuit 424 have a predetermined timing relationship. As the predetermined timing relationship, a timing relationship in which the timing of a signal of recurrence from the recurrent layer in the neural network shown in FIG. 9 coincides with the timing of information of a signal which is subsequent by a predetermined time in the hidden layer in the forward coupling is used in this embodiment.

The adder circuit 424 adds the signal (the signal which is the result of the product-sum operation in this embodiment) input from the synchronous array unit 421 and the signal (the signal which is the result of the product-sum operation in this embodiment) input from the recurrent synchronous array unit 422 and outputs a signal which is the result of addition to the activation function circuit 425.

The activation function circuit 425 outputs a signal, which is the operation result of a predetermined activation function f( ) when the signal input from the adder circuit 424 is substituted into the activation function f( ), to the retention mechanism 427 and the output buffer 426.

Here, the array device 401 according to this embodiment has a configuration including the activation function circuit 425, but a configuration not including the activation function circuit 425 may be used in another configuration example. In this case, the signal output from the detection circuit 424 is output to the retention mechanism 427 and the output buffer 426.

The output buffer 426 temporarily stores a signal input from the activation function circuit 425 and outputs the stored signal to the outside.

The retention mechanism 427 retains (stores) a signal (a value thereof) input from the activation function circuit 425. Then, the retention mechanism 427 is controlled by the synchronization circuit 423 and outputs the retained signal (the value thereof) to the recurrent synchronous array unit 422.

Here, the retention mechanism 427 may be constituted, for example, using a memory such as a register that retains (stores) a signal (a value thereof).

The retention mechanism 427 may give a delay of an arbitrary time to a signal (a value thereof) which is read after being retained, and a delay of one unit time is given in this embodiment.

Here, when output data y^{t} is output in response to input data x^{t} at time t, a signal y^{t-1} which is input from the retention mechanism 427 to the recurrent synchronous array unit 422 is a signal which is obtained by delaying the output data y^{t}. In this embodiment, a signal y^{t-1} which is obtained by delaying time t by 1 is recurred.

In this embodiment, the array device 401 is configured to be able to output a signal (a signal which is the operation result of the activation function f( )) corresponding to a signal output from the hidden layer in the forward coupling shown in FIG. 9.

For example, when one or more circuits of the conversion circuits 522 and 622, the detection circuits 524 and 624, and the output buffers 525, 625, and 426 may be omitted, the circuit may not be provided in the array device 401.

As described above, in the array device 401 according to this embodiment, a recurrent computing operation can be performed using a neuromorphic element. In the array device 401 according to this embodiment, a recurrent neural network can be simply constructed using the neuromorphic element.

The array device 401 according to this embodiment includes a first array area (the area of the recurrent weighting array 623 in this embodiment) that includes a neuromorphic element multiplying a signal by a weight corresponding to a variable characteristic value and outputs a first signal (a signal output from the recurrent weighting array 623 in this embodiment) which is the result of processing an input signal using the neuromorphic element. The array device 401 according to this embodiment includes a retention unit (the retention mechanism 427 in this embodiment) that retains a second signal (a signal output from the activation function circuit 425 in this embodiment) which is output when the first signal output from the first array area is input to a predetermined computing unit (the adder circuit 424 and the activation function circuit 425 in this embodiment) and inputs the retained second signal to the first array area.

According to this configuration, in the array device 401 according to this embodiment, it is possible to perform recurrent processing in the array device 401 using the retention mechanism 427 and the re-input mechanism (for example, the mechanism of the synchronization circuit 423) and to construct, for example, a recurrent neural network with high extensibility of which control is easy.

Here, in the array device 401 according to this embodiment, the first array area is a recurrent array area. The predetermined computing unit performs addition of the signal output from the second array area (the area of the weighting array 523 in this embodiment) other than the first array area and a computing operation using a predetermined activation function.

In this embodiment, the weighting array 523 and the recurrent weighting array 623 are constituted as independent arrays, but an area in the same array may be divided into two or more and the function of the weighting array 523 and the function of recurrent weighting array 623 may be implemented in different areas in the same array in another configuration. In this case, for example, a constituent unit of a recurrent neural network can be implemented in a small size, for example, by mapping the weight of an input-side layer (the input layer in this embodiment) and the weight of the recurrent layer on one array and providing a recurrent input mechanism.

Here, in the array device 401 according to this embodiment, output signals (signals output from the activation function circuit 425 in this embodiment) of all the units in the hidden layer are input as signals of recurrence to the recurrent weighting array 623, but a configuration in which output signals of some units (some signals output from the activation function circuit 425 in this embodiment) in the hidden layer are input as signals of recurrence to the recurrent weighting array 623 may be used in another example. For example, a configuration in which a unit that inputs an output signal of a unit as a signal of recurrence to the recurrent weighting array 623 and a unit not performing such recurrence can be switched to each other among a plurality of units in the hidden layer may be used. Such switching may be manually performed by a user or may be automatically performed by a control unit (not shown) in accordance with a predetermined rule.

According to this configuration, in the array device 401, it is possible to cause only output signals from some units in a recurrent mechanism to recur and, for example, to dynamically reconstruct an array device which is specialized in identification of applications.

The array device 1 shown in FIG. 1 and the array device 401 shown in FIG. 5 can perform the same processing, but the array device 1 shown in FIG. 1 can be easily constructed with a simpler configuration.

### Fifth Embodiment

In this embodiment, a neuromorphic element which is used in the arrays according to the first to fourth embodiments (for example, the weighting arrays 23, 131, 322, and 523, the recurrent weighting arrays 24, 132, and 623, the input-gate weighting array 141, the input-gate recurrent weighting array 142, the forgetting-gate weighting array 151, the forgetting-gate recurrent weighting array 152, the output-gate weighting array 161, and the output-gate recurrent weighting array 162) will be described below.

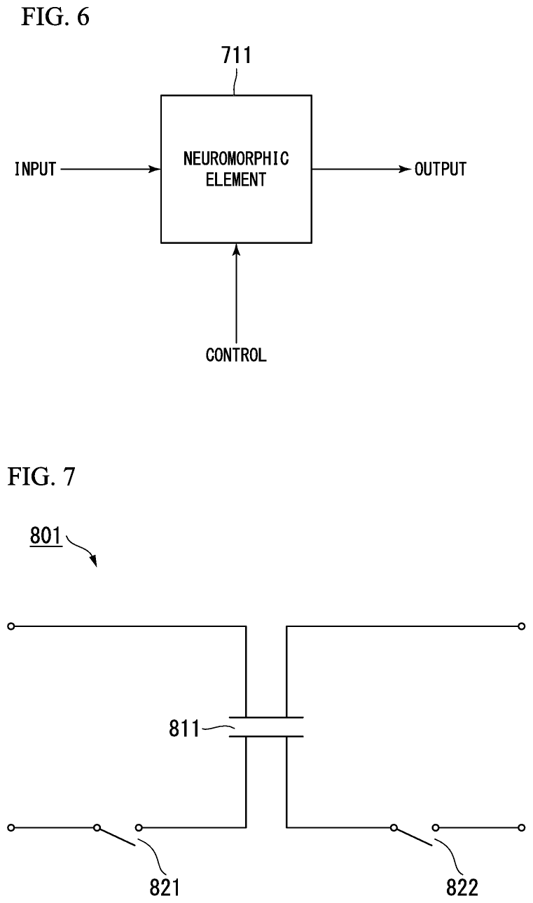

FIG. 6 is a diagram schematically showing a configuration of a neuromorphic element 711 according to an embodiment (a fifth embodiment) of the invention.

The neuromorphic element 711 is controlled by a control signal which is input from a control unit (not shown) assigning weights, and the values of the weights change with change in characteristics (for example, conductance) of the neuromorphic element 711. The neuromorphic element 711 multiplies the weights (the values thereof) corresponding to the characteristics of the neuromorphic element 711 by an input signal and outputs a signal which is the result of multiplication.

For example, when the neuromorphic element 711 of which resistance R is variable is used as a function of a multiplier, conductance G (=1/R) of the neuromorphic element 711 is used, a voltage V is input as an input signal to the neuromorphic element 711, and the magnitude of a current I (=G×V) flowing in the neuromorphic element 711 at that time is used as the result of multiplication.

In a configuration in which a plurality of neuromorphic elements 711 are included in the arrays (for example, the weighting arrays 23, 131, 322, and 523, the recurrent weighting arrays 24, 132, and 623, the input-gate weighting array 141, the input-gate recurrent weighting array 142, the forgetting-gate weighting array 151, the forgetting-gate recurrent weighting array 152, the output-gate weighting array 161, and the output-gate recurrent weighting array 162), for example, the neuromorphic elements 711 may be individually controlled, all the neuromorphic elements 711 may be controlled together, or the plurality of neuromorphic elements 711 may be classified into two or more different groups and be controlled together for each group.

Here, when a neuromorphic element 711 in which the change in characteristics varies is used, it is preferable that the neuromorphic element 711 be controlled in consideration of that point. An element in which the change in characteristics varies refers to, for example, an element in which the change in characteristics is nonlinear.

For example, in a neuromorphic element 711 in which the change in conductance (ΔG) varies, the change in conductance (ΔG) with respect to a constant change of a voltage V which is applied to the neuromorphic element 711 may increase as the value of conductance varies from a lower value to a higher value. In this case, for example, a configuration in which the change of the voltage V (the change for each switching step) applied to the neuromorphic element 711 decreases as the value of conductance varies from a lower value to a higher value may be used to switch the change in conductance (ΔG) of the neuromorphic element 711 at constant intervals. Alternatively, a configuration in which the change in weight to be assigned varies with variation of the change in conductance (ΔG) may be used.

Even when the change in characteristics of a neuromorphic element 711 varies in another manner, control can be performed to correspond to the manner. For example, this control method may be mounted in advance and stored in a predetermined storage unit or the like.

An arbitrary element may be used as the neuromorphic element 711. As the neuromorphic element 711, for example, a plurality of neuromorphic elements of one type may be combined and used or a plurality of neuromorphic elements of two or more types may be combined and used.

For example, an element which uses a phase change memory (PCM) controlling phase change between a crystalline phase and an amorphous phase step by step may be used as the neuromorphic element 711.

For example, an element using a conductive bridge random access memory (CBRAM) in which formation and disappearance of path between deposition and ionization of metal due to an electrochemical reaction is used may be used as the neuromorphic element 711.

For example, an element using spintronics may be used as the neuromorphic element 711 and, for example, a domain wall type element causing linear resistance change due to control of a magnetic domain wall or a spin-orbit torque (SOT) type element using magnetization inversion due to a spin-orbit torque action may be used.

For example, an element using a resistive random access memory (ReRAM) in which resistance change is used by forming a filament due to deposition of metal in a medium such as TaO₂ may be used as the neuromorphic element 711.

An element of which arbitrary characteristics can be changed may be used as the neuromorphic element 711, or an element of which characteristics such as resistance or an optical phase can be changed may be used.

As described above, in the array device according to this embodiment, various neuromorphic elements 711 can be used and a product-sum operation using an array or the like can be implemented.

### Sixth Embodiment

In this embodiment, a retention mechanism that can be used as a retention mechanism (for example, the retention mechanisms 27, 171, and 427) in the first to fourth embodiments will be described.

FIG. 7 is a diagram schematically showing a configuration of a retention mechanism 801 according to an embodiment (a sixth embodiment) of the invention.

The retention mechanism 801 includes a capacitive element 811, an input-side switch 821, and an output-side switch 822.

In this embodiment, a switching circuit that is configured to perform charging/discharging switching of the capacitive element 811 is constituted by the input-side switch 821 and the output-side switch 822.

The input-side switch 821 is switched between a closed state (closed) in which an electrical signal flows and an open state (open) in which an electrical signal is blocked.

When the input-side switch 821 is in the closed state, electric charge is accumulated in the capacitive element 811 by a signal (for example, a current) input from the outside to the retention mechanism 801. When the input-side switch 821 is in the open state, an input-side signal (for example, a current) does not flow.

The output-side switch 822 is switched between a closed state (closed) in which an electrical signal flows and an open state (open) in which an electrical signal is blocked.

When the output-side switch 822 is in the closed state, electric charge accumulated in the capacitive element 811 flows out from the retention mechanism 801 and a signal (for example, a current) due thereto is output from the retention mechanism 801. When the output-side switch 822 is in the open state, an output-side signal (for example, a current) does not flow.

In this embodiment, in the retention mechanism 801, electric charge corresponding to a signal (for example, a current) input from the outside is accumulated in the capacitive element 811 by switching the input-side switch 821 to the closed state and switching the output-side switch 822 to the open state. Thereafter, in the retention mechanism 801, a signal (for example, a current) corresponding to electric charge accumulated in the capacitive element 811 is output to the outside by switching the input-side switch 821 to the open state and switching the output-side switch 822 to the closed state.

A signal (for example, a current) which is output from the retention mechanism 801 to the outside may be converted into a signal of a voltage, for example, using a resistor.

As described above, in the array device according to this embodiment, the retention unit (the retention mechanism 801 in this embodiment) includes a capacitive element (the capacitive element 811 in this embodiment) that stores a current corresponding to a signal (the first signal or the second signal) and a switching circuit (the input-side switch 821 and the output-side switch 822 in this embodiment) that performs charging/discharging switching of the capacitive element.

According to this configuration, in the array device according to this embodiment, power consumption performance can be enhanced by retaining a signal in an analog manner.

Here, another retention mechanism may be used as the retention mechanisms according to the first to fourth embodiments (for example, the retention mechanisms 27, 171, and 427).

For example, a retention mechanism that retains data after an analog signal (for example, an analog current) has been converted into a digital value may be used. In this case, for example, the retention mechanism may be configured to retain a digital value (data) acquired from the outside of the retention mechanism, or the retention mechanism may be configured to receive an analog signal, to convert the analog signal into a digital value, and to retain the digital value. In this configuration, the retention mechanism may include an analog-to-digital (A/D) converter that converts the analog signal into a digital value.

In this array device, the retention unit retains data after a current corresponding to a signal (the first signal or the second signal) has been converted into a digital value.

According to this configuration, it is possible to facilitate development or the like of the array device by retaining a signal in a digital value.

### Seventh Embodiment

In this embodiment, a line which is common to a plurality of arrays will be described below.

For example, a line (hereinafter also referred to as a “vertical line” (which may be referred to as a column line) for the purpose of convenience of description) which is common to the weighting array 23 and the recurrent weighting array 24 according to the first embodiment shown in FIG. 1 may be used.

For example, a line (hereinafter also referred to as a “vertical line” for the purpose of convenience of description) which is common to the weighting array 131 and the recurrent weighting array 132 according to the second embodiment shown in FIG. 3 may be used. Similarly, a line (hereinafter also referred to as a “vertical line” for the purpose of convenience of description) which is common to the input-gate weighting array 141 and the input-gate recurrent weighting array 142 may be used. Similarly, a line (hereinafter also referred to as a “vertical line” for the purpose of convenience of description) which is common to the forgetting-gate weighting array 151 and the forgetting-gate recurrent weighting array 152 may be used. Similarly, a line (hereinafter also referred to as a “vertical line” for the purpose of convenience of description) which is common to the output-gate weighting array 161 and the output-gate recurrent weighting array 162 may be used.

For example, in the synchronous array units 241 and 242 according to the third embodiment shown in FIG. 4, similarly to the first embodiment, a line (hereinafter also referred to as a “vertical line” for the purpose of convenience of description) which is common to the weighting array and the recurrent weighting array may be used.

For example, a line (hereinafter also referred to as a “horizontal line” (which may be referred to as a row line) for the purpose of convenience of description) which is common to the weighting array 131, the input-gate weighting array 141, the forgetting-gate weighting array 151, and the output-gate weighting array 161 according to the second embodiment which are shown in FIG. 3 may be used. Similarly, a line (hereinafter also referred to as a “horizontal line” for the purpose of convenience of description) which is common to the recurrent weighting array 132, the input-gate recurrent weighting array 142, the forgetting-gate recurrent weighting array 152, and the output-gate recurrent weighting array 162 may be used.

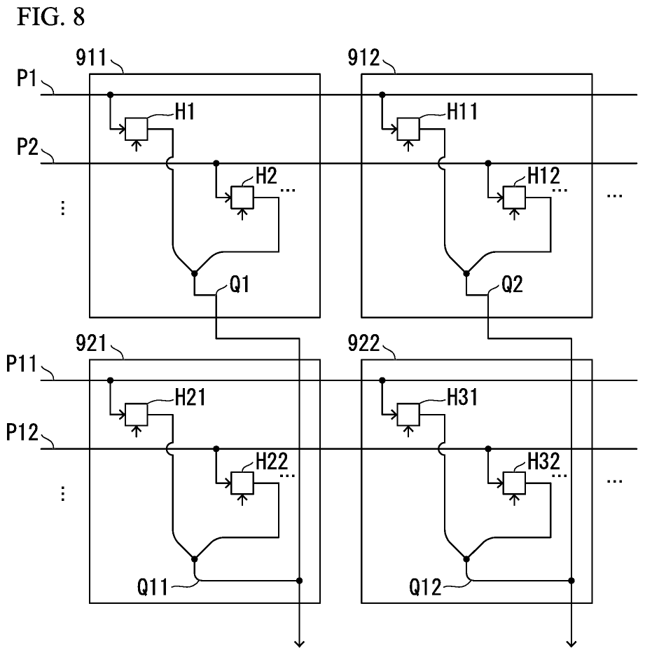

For the purpose of convenience of description, a common vertical line and a common horizontal line will be described below together with reference to FIG. 8. The common vertical line and the common horizontal line may be used dependently or may be used in arbitrary combination.

A vertical line which is common to two or more different arrays will be described below with reference to FIG. 8, and the same is true of a vertical line which is common to three or more different arrays.

A horizontal line which is common to two or more different arrays will be described below with reference to FIG. 8 for the purpose of convenience of description, and the same is true of a horizontal line which is common to three or more different arrays.

FIG. 8 is a diagram schematically showing a configuration of a line common to a plurality of arrays 911, 912, 921, and 922 according to an embodiment (a seventh embodiment) of the invention.

Common horizontal lines P1 and P2 are disposed in the array 911 and the array 912.

Common horizontal lines P11 and P12 are disposed in the array 921 and the array 922.

A common vertical line Q1 is disposed in the array 911 and the array 921.

A common vertical line Q2 is disposed in the array 912 and the array 922.

In the array 911, one end of a neuromorphic element H1 is connected to the horizontal line P1.

In the array 911, one end of a neuromorphic element H2 is connected to the horizontal line P2.

In the array 911, the other end of the neuromorphic element H1 and the other end of the neuromorphic element H2 are connected to the vertical line Q1.

In the array 912, one end of a neuromorphic element H11 is connected to the horizontal line P1.

In the array 912, one end of a neuromorphic element H12 is connected to the horizontal line P2.

In the array 912, the other end of the neuromorphic element H11 and the other end of the neuromorphic element H12 are connected to the vertical line Q2.

In the array 921, one end of a neuromorphic element H21 is connected to the horizontal line P11.

In the array 921, one end of a neuromorphic element H22 is connected to the horizontal line P12.

In the array 921, the other end of the neuromorphic element H21 and the other end of the neuromorphic element H22 are connected to a line Q11. The line Q11 is connected to the line Q1.

In the array 922, one end of a neuromorphic element H31 is connected to the horizontal line P11.

In the array 922, one end of a neuromorphic element H32 is connected to the horizontal line P12.

In the array 922, the other end of the neuromorphic element H31 and the other end of the neuromorphic element H32 are connected to a line Q12. The line Q12 is connected to the line Q2.

According to the above-mentioned configuration, in the array 911, a signal which is the result of addition of a signal which is the result of weighting a signal flowing in the horizontal line P1 using the neuromorphic element H1 and a signal which is the result of weighting a signal flowing in the horizontal line P2 using the neuromorphic element H2 flows in the vertical line Q1 and is transmitted to the array 921.

In the array 921, a signal which is the result of addition of a signal which is the result of weighting a signal flowing in the horizontal line P11 using the neuromorphic element H21 and a signal which is the result of weighting a signal flowing in the horizontal line P12 using the neuromorphic element H22 flows in the line Q11 and is transmitted to the vertical line Q1. As a result, a signal which is the result of addition of the signal transmitted from the array 911 and the signal transmitted from the line Q11 of the array 921 flows in the vertical line Q1.

By employing this configuration, it is possible to sum the results of product-sum operations in a plurality of arrays 911 and 921.

According to the above-mentioned configuration, in the array 912, a signal which is the result of addition of a signal which is the result of weighting a signal flowing in the horizontal line P1 using the neuromorphic element H11 and a signal which is the result of weighting a signal flowing in the horizontal line P2 using the neuromorphic element H12 flows in the vertical line Q2 and is transmitted to the array 922.

In the array 922, a signal which is the result of addition of a signal which is the result of weighting a signal flowing in the horizontal line P11 using the neuromorphic element H31 and a signal which is the result of weighting a signal flowing in the horizontal line P12 using the neuromorphic element H32 flows in the line Q12 and is transmitted to the vertical line Q2. As a result, a signal which is the result of addition of the signal transmitted from the array 912 and the signal transmitted from the line Q12 of the array 922 flows in the vertical line Q2.

By employing this configuration, it is possible to sum the results of product-sum operations in a plurality of arrays 912 and 922.

Here, in the example shown in FIG. 8, two common horizontal lines P1 and P2 and two common horizontal lines P11 and P12 in the arrays 911, 912, 921, and 922 are shown, but the number of common horizontal lines may be arbitrary.

In the example shown in FIG. 8, one common vertical line Q1 and one common vertical line Q2 in the arrays 911, 912, 921, and 922 are shown, but the number of common vertical lines may be arbitrary.

In this embodiment, a circuit that performs a product-sum operation corresponding to a desired neural network is constituted using a plurality of neuromorphic elements in the arrays 911, 912, 921, and 922. The circuits of the arrays 911, 912, 921, and 922 are arranged, for example, in a matrix shape.

As described above, in the array device according to this embodiment, a signal (the first signal or the second signal) which is input from the retention unit to the first array area (for example, the arrays 921 and 922) and the other signal (for example, the signals which are input from the arrays 911 and 912) which is input to the first array area are output via the same line (for example, the vertical lines Q1 and Q2).

According to this configuration, in the array device according to this embodiment, for example, it is possible to achieve reduction of arrays and communization of peripheral circuits.

By employing a configuration in which a new input signal (a temporarily subsequent signal) and a recurrent signal (a signal of information which is temporally previous) are input to at least a part of lines, it is possible to simplify arrangement of lines.

### Conclusion of Above Embodiments

The above-mentioned processes may be performed by recording a program for realizing the functions of the devices (for example, the control unit such as the control circuit 222) described in the above-mentioned embodiments on a computer-readable recording medium (storage medium) and causing a computer system to read and execute the program recorded on the recording medium.

The “computer system” mentioned herein may include an operating system (OS) or hardware such as peripherals.

Examples of the “computer-readable recording medium” include a flexible disk, a magneto-optical disk, a read only memory (ROM), a rewritable nonvolatile memory such as a flash memory, a portable medium such as a digital versatile disc (DVD), and a storage device such as a hard disk built in a computer system. A recording medium may be, for example, a recording medium that temporarily stores data.

The “computer-readable recording medium” may include a medium that holds a program for a predetermined time like a volatile memory (for example, a dynamic random access memory (RAM)) in a computer system serving as a server or a client when a program is transmitted via a network such as the Internet or a communication line such as a telephone line.

The program may be transmitted from a computer system storing the program in a storage device or the like to another computer system via a transmission medium or carrier waves in the transmission medium. Here, the “transmission medium” for transmitting the program means a medium having a function of transmitting information like a network (a communication network) such as the Internet or a communication circuit (a communication line) such as a telephone circuit.

The program may be designed to realize some of the above-mentioned functions. The program may be a so-called differential file (a differential program) which can realize the above-mentioned functions in combination with a program which has already been recorded in a computer system.

The embodiments of the invention can also be applied to a binarized neural net, which will be described below.

In general, a neuromorphic element refers to a nonvolatile element in which conductance can be set to multiple steps within a given range, and thus provides a function of performing a product-sum operation in an analog manner using the Ohm's law of voltage×conductance=current. For example, an element in which 1 (micro-Siemens), 1.25 μS, 1.5 μS, 1.75 μS, and 2 μS can be set as the conductance can perform a product-sum operation with a quantization resolution of five steps between 1 μS and 2 μS.

However, in research in the field in which a neural net is implemented by CMOS digital computing elements, reduction of an operational word length has been studied recently. In a most extreme case, an attempt to digitize an input signal, a weight, or an activation function output has been actively studied. Such a digitized neural network is referred to as, for example, a binarized neural net or a binary neural network. For example, when a weight and an input value are assumed to take −1 and 1 and they are calculated using a logical element having values of 0 and 1, a product-sum operation can be carried out using the following four types of XNOR logical operations and a counter of an element in a state of “1.”

0(−1)×0(−1)=1(1)

0(−1)×1(1)=0(−1)

1(1)×0(−1)=0(−1)

1(1)×1(1)=1(1) These operations are also possible, for example, when a neuromorphic element having resistance change of two steps is used. The binarized neural net is not essential of the present application and thus will not be described in detail. However, the technology according to the present application can be applied to a case in which a recurrent configuration is provided using such a binarized neural net.

The above-mentioned neural network system can serve as a brain of various sensors or robots. For example, when a signal output from a sensor (hereinafter also referred to as a sensor signal for the purpose of convenience of description) is input to a controller using such a neural network system, the controller can serve as an edge element. There is generally a lot of noise in a sensor signal, and a general sensor module can extract a desired sensor signal from the noise. Accordingly, a method of removing noise from time-series signals of the sensor signal, for example, using a signal processing technique and extracting a desired signal is used. In this case, the part other than the acquired signal merely consumes energy and does not generate information. It is possible to perform recognition with high accuracy by inputting a sensor signal to a controller using the neural network system. Conventionally, significant information is first extracted by separating an observed signal in which noise is superimposed on a source signal into the source signal and the noise, but a source signal which is desired to acquire from time-series signals including noise can be predicted by using the controller using the neural network system and a significant signal can be extracted even when the output intensity or the statistical value of the source signal is small. Such a module is a module into which a sensor and a controller are unified and can be used as an artificial intelligence (AI) edge sensor module.

When a controller using the neural network system is used, recognition accuracy is enhanced and thus it is possible to extract information with less computing performance and to achieve a decrease in cost, power saving, and a decrease in volume.

It is preferable that signals of a plurality of sensor be input to a controller using the neural network system.

By simultaneously inputting signals of a plurality of sensors to a controller, it is possible to acquire recognition associated with a relationship between the sensors. For example, when sensors are installed in hands, legs, and a body of a robot and signals from the sensors are simultaneously input to a controller, information on whether the robot is walking or falls can be multiply determined using the signals. In a robot, a vehicle, or the like in which a plurality of AI edge sensor modules are installed, it is possible to expect achievement of power saving or improvement in functionality by simultaneously inputting signals to a controller. When a plurality of sensors are different types of sensors, it is necessary to install a controller capable of coping with voltages or currents corresponding to the sensors. In this case, a transformer, an analog-to-digital (AD) converter, or the like may be required for an interface of the controller, and energy can be consumed due to energy conversion. The AI edge sensor module also consumes energy, but a signal output from the AI edge sensor module to a central controller has been recognized and identified by the AI edge sensor module and thus, for example, only necessary information can be transmitted from the AI edge sensor module to the central controller. Since an amount of data communicating between the AI edge sensor module and the central controller can be reduced by this function, it is possible to reduce energy consumption of a system as a whole.

While embodiments of the invention have been described above with reference to the drawings, a specific configuration of the invention is not limited to the embodiments and includes changes in design without departing from the gist of the invention.

The recurrent computing operation may be used, for example, in the field of neural networks or may be used in the fields other than neural networks.

### INDUSTRIAL APPLICABILITY

With the array device according to the invention, it is possible to perform a recurrent computing operation using neuromorphic elements.

### REFERENCE SIGNS LIST

1, 101, 401 Array device
21, 121, 521, 621 Input interface
22, 122, 522, 622 Conversion circuit
23, 131, 322, 523 Weighting array
24, 132, 623 Recurrent weighting array
25, 133, 143, 153, 163, 524, 624 Detection circuit
26, 134, 144, 154, 164, 323, 425 Activation function circuit
27, 271, 427, 801 Retention mechanism
28, 172, 423, 526, 626 Synchronization circuit
29, 173, 426, 525, 625 Output buffer
141 Input-gate weighting array
142 Input-gate recurrent weighting array
151 Forgetting-gate weighting array
152 Forgetting-gate recurrent weighting array
161 Output-gate weighting array
162 Output-gate recurrent weighting array
181-183 Computing unit
201 Neural network system
202 Image sensor
203 Automatic driving control unit
221 Device interface
222 Control circuit
223 Output communication interface
231 Feature extracting unit
232 Identification unit
241-242, 311, 421, 422 Synchronous array unit
321 Buffer
424 Adder circuit
711, H1-H2, H11-H12, H21-H22, H31-H32 Neuromorphic element
811 Capacitive element
821-822 Switch
911-912, 921-922 Array
P1-P2, P11-P12 Horizontal line
Q1-Q2 Vertical line
Q11-Q12 Line
1011-0-1011-n, 1021-0-1021-m, 1031-1-1031-r, 1111-0-1111-s, 1121-0-1121-s Unit
2001 Array unit
2011 Input layer
2012 Hidden layer
2013 Output layer
3011, 3021 Input weight unit
3012, 3022 Recurrent layer unit
3013, 3023 Activation function unit

1. An array device comprising:
a first array area that includes a neuromorphic element which is configured to multiply a signal by a weight corresponding to a variable characteristic value and that is configured to output a first signal which is a result of processing an input signal using the neuromorphic element; and
a retention unit that is able to retain the first signal output from the first array area or a second signal which is output when the first signal is input to a predetermined computing unit and is configured to input the retained first signal or the retained second signal to the first array area.

2. The array device according to claim 1, wherein the retention unit includes a capacitive element that is configured to store a current corresponding to the first signal or the second signal and a switching circuit that is configured to perform charging/discharging switching of the capacitive element.

3. The array device according to claim 1, wherein the retention unit is configured to retain data after the current corresponding to the first signal or the second signal has been converted into a digital value.

4. The array device according to claim 1, wherein the first signal or the second signal which is input from the retention unit to the first array area is synchronized with another signal which is input to the first array area.

5. The array device according to claim 4, wherein the first signal or the second signal which is input from the retention unit to the first array area and the other signal which is input to the first array area are both data in discrete unit times, and
wherein the other signal is a signal which is temporally subsequent to the first signal or the second signal which is input from the retention unit to the first array area.

6. The array device according to claim 4, wherein the first signal or the second signal which is input from the retention unit to the first array area and the other signal which is input to the first array area are output via the same line.

7. The array device according to claim 1, wherein the first array area includes a plurality of different areas including a common line and outputs signals from the plurality of areas as the first signal, and
wherein the retention unit is table to retain the second signal which is output when the signals output from the plurality of areas of the first array area are input to the computing unit and is configured to input the retained second signal to one or more of the plurality of areas of the first array area.

8. A neural network system comprising the array device according to claim 1 and performing processing of a neural network.
